(19) United States
(12) Patent Application Publication
(10) Pub. No.: US 2026/0270684 A1
(43) Pub. Date: Sep. 10, 2026

(54) ENERGY HARVESTING CAPABILITY REPORT FOR AMBIENT ENERGY HARVESTING DEVICES

(71) Applicant: QUALCOMM Incorporated, San Diego, CA (US)

(72) Inventors: Luanxia YANG, Beijing (CN); Xiaojie WANG, Hillsborough, NJ (US); Xiaoxia ZHANG, San Diego, CA (US); Junyi LI, Fairless Hills, PA (US)

(21) Appl. No.: 19/157,985

(22) PCT Filed: Mar. 21, 2023
(86) PCT No.: PCT/CN2023/082709

§ 371 Date: Aug. 19, 2025

(51) Int. Cl. H04W 8/24; H04W 24/10

(52) U.S. Cl. CPC H04W 8/24; H04W 24/10

(57) ABSTRACT

Methods, systems, and devices for wireless communications are described. An energy harvesting device, such as a user equipment (UE) or a radiofrequency identification (RFID) tag, may transmit a control message indicating a capability of the energy harvesting device to use one or more energy sources for energy harvesting. The energy harvesting device may receive, in accordance with the capability indicated in the control message, control signaling indicating one or more parameters associated with the energy harvesting. The energy harvesting device may perform, during an energy harvesting measurement window, an energy harvesting procedure to produce one or more energy harvesting measurements and transmit an energy harvesting report indicating the one or more energy harvesting measurements and an efficiency metric for the energy harvesting from at least one of the one or more energy sources during the energy harvesting measurement window.

### CROSS REFERENCE

This application is a 371 National Stage of PCT Application No. PCT/CN2023/082709, filed on Mar. 21, 2023, entitled “ENERGY HAR VESTING CAPABILITY REPORT FOR AMBIENT ENERGY HARVESTING DEVICES”, and assigned to the assignee hereof. The disclosure of the prior Application is considered part of and is incorporated by reference into this Patent Application.

### FIELD OF TECHNOLOGY

The following relates to wireless communications, including energy harvesting capability report for ambient energy harvesting devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support energy harvesting capability report for ambient energy harvesting devices. For example, the described techniques provide for an energy harvesting device to transmit a capability report indicating the capabilities of the energy harvesting device. For example, the capability report may indicate energy sources supported by the energy harvesting device, such as solar-based sources, radio frequency-based sources, thermal-based sources, wind-based sources, and the like. The capability report may indicate whether the energy harvesting device has an external energy assistant for performing different operations as well as sensitivity thresholds for performing the operations while using the external energy assistant. In some examples, the capability report may indicate different characteristics or parameters of an energy storage component of the energy harvesting device, such as a battery or capacitor of the energy harvesting device. In some examples, the energy harvesting device may transmit an energy harvesting report indicating energy harvesting accessibility or efficiencies for each of the sources. In some examples, the energy harvesting device may be configured with an energy harvesting measurement window, and the energy harvesting device may perform energy harvesting measurements during the energy harvesting measurement window. The energy harvesting measurements may indicate an amount of harvested energy, an amount of harvested power, or a conversion efficiency, or any combination thereof, during the energy harvesting measurement window, for one or more of the energy sources. The energy harvesting report may report indicating the one or more energy harvesting measurements for one or more of the energy sources. The energy harvesting report may also indicate an efficiency metric such as, for example, a highest efficiency between the energy sources, one or more energy sources having a highest (or next highest) efficiency, an average efficiency of each of the energy sources, or a highest observed efficiency of all of the energy sources during the measurement window.

A method for wireless communications at an energy harvesting device is described. The method may include transmitting a control message indicating a capability of the energy harvesting device to use one or more energy sources for energy harvesting, receiving, in accordance with the capability indicated in the control message, control signaling indicating one or more parameters associated with the energy harvesting, performing, during an energy harvesting measurement window, an energy harvesting procedure in accordance with the one or more parameters to produce one or more energy harvesting measurements, and transmitting an energy harvesting report indicating the one or more energy harvesting measurements and an efficiency metric for the energy harvesting from at least one of the one or more energy sources during the energy harvesting measurement window.

An apparatus for wireless communications at an energy harvesting device is described. The apparatus may include a processor, memory coupled with the processor, and instructions stored in the memory. The instructions may be executable by the processor to cause the apparatus to transmit a control message indicating a capability of the energy harvesting device to use one or more energy sources for energy harvesting, receive, in accordance with the capability indicated in the control message, control signaling indicating one or more parameters associated with the energy harvesting, perform, during an energy harvesting measurement window, an energy harvesting procedure in accordance with the one or more parameters to produce one or more energy harvesting measurements, and transmit an energy harvesting report indicating the one or more energy harvesting measurements and an efficiency metric for the energy harvesting from at least one of the one or more energy sources during the energy harvesting measurement window.

Another apparatus for wireless communications at an energy harvesting device is described. The apparatus may include means for transmitting a control message indicating a capability of the energy harvesting device to use one or more energy sources for energy harvesting, means for receiving, in accordance with the capability indicated in the control message, control signaling indicating one or more parameters associated with the energy harvesting, means for performing, during an energy harvesting measurement window, an energy harvesting procedure in accordance with the one or more parameters to produce one or more energy harvesting measurements, and means for transmitting an energy harvesting report indicating the one or more energy harvesting measurements and an efficiency metric for the energy harvesting from at least one of the one or more energy sources during the energy harvesting measurement window.

A non-transitory computer-readable medium storing code for wireless communications at an energy harvesting device is described. The code may include instructions executable by a processor to transmit a control message indicating a capability of the energy harvesting device to use one or more energy sources for energy harvesting, receive, in accordance with the capability indicated in the control message, control signaling indicating one or more parameters associated with the energy harvesting, perform, during an energy harvesting measurement window, an energy harvesting procedure in accordance with the one or more parameters to produce one or more energy harvesting measurements, and transmit an energy harvesting report indicating the one or more energy harvesting measurements and an efficiency metric for the energy harvesting from at least one of the one or more energy sources during the energy harvesting measurement window.

In some examples of the method, apparatuses, and non-transitory computer-readable medium described herein, transmitting the control message may include operations, features, means, or instructions for transmitting the control message indicating the capability of the energy harvesting device to use a solar-based energy source, a radio frequency-based energy source, a wind-based energy source, a thermal-based energy source, or any combination thereof, for the energy harvesting.

In some examples of the method, apparatuses, and non-transitory computer-readable medium described herein, receiving the control signaling may include operations, features, means, or instructions for receiving the control signaling indicating the one or more parameters that identifies a duty cycle parameter for an energy harvesting signal, where performing the energy harvesting procedure may be based on the duty cycle parameter for the energy harvesting signal.

In some examples of the method, apparatuses, and non-transitory computer-readable medium described herein, the energy harvesting report identifies the efficiency metric for one energy source of the one or more energy sources based on the one energy source having a highest efficiency metric among the one or more energy sources.

In some examples of the method, apparatuses, and non-transitory computer-readable medium described herein, the efficiency metric may be power harvesting efficiency, energy harvesting efficiency, conversion efficiency, or any combination thereof.

In some examples of the method, apparatuses, and non-transitory computer-readable medium described herein, transmitting the energy harvesting report may include operations, features, means, or instructions for transmitting the energy harvesting report indicating the one or more energy harvesting measurements that identifies a respective efficiency of each energy source of the one or more energy sources based on performing the energy harvesting procedure.

In some examples of the method, apparatuses, and non-transitory computer-readable medium described herein, the energy harvesting report indicates a respective highest efficiency of each energy source during the energy harvesting measurement window.

In some examples of the method, apparatuses, and non-transitory computer-readable medium described herein, the energy harvesting report indicates a respective average efficiency of each energy source during the energy harvesting measurement window.

In some examples of the method, apparatuses, and non-transitory computer-readable medium described herein, transmitting the energy harvesting report may include operations, features, means, or instructions for transmitting the energy harvesting report periodically, where the one or more parameters indicate a periodicity for the energy harvesting report.

Some examples of the method, apparatuses, and non-transitory computer-readable medium described herein may further include operations, features, means, or instructions for receiving a grant scheduling a resource for the energy harvesting report, where the energy harvesting report may be transmitted using the resource.

Some examples of the method, apparatuses, and non-transitory computer-readable medium described herein may further include operations, features, means, or instructions for detecting a trigger to transmit the energy harvesting report, where the energy harvesting report may be transmitted based on the trigger.

In some examples of the method, apparatuses, and non-transitory computer-readable medium described herein, the trigger may be based on an efficiency of an energy source of the one or more energy sources failing to satisfy a first threshold or an energy harvesting measurement of the one or more energy harvesting measurements failing to satisfy a second threshold, or both.

In some examples of the method, apparatuses, and non-transitory computer-readable medium described herein, the one or more parameters associated with the energy harvesting includes the first threshold or the second threshold, or both.

In some examples of the method, apparatuses, and non-transitory computer-readable medium described herein, the energy harvesting procedure may be performed based on detecting the trigger.

In some examples of the method, apparatuses, and non-transitory computer-readable medium described herein, transmitting the control message may include operations, features, means, or instructions for transmitting the control message indicating a respective sensitivity threshold for one or more operations.

In some examples of the method, apparatuses, and non-transitory computer-readable medium described herein, the control message indicates, for each operation of the one or more operations, a first sensitivity threshold based on using an external energy source and a second sensitivity threshold based on not using the external energy source.

In some examples of the method, apparatuses, and non-transitory computer-readable medium described herein, the respective sensitivity threshold for the one or more operations may be based on a traffic priority or a latency associated with each operation of the one or more operations.

In some examples of the method, apparatuses, and non-transitory computer-readable medium described herein, transmitting the control message may include operations, features, means, or instructions for transmitting the control message indicating one or more external energy sources of the energy harvesting device.

In some examples of the method, apparatuses, and non-transitory computer-readable medium described herein, the control message indicates support for using a variable energy draw from the one or more external energy sources.

In some examples of the method, apparatuses, and non-transitory computer-readable medium described herein, transmitting the control message may include operations, features, means, or instructions for transmitting the control message indicating an energy storage component of the energy harvesting device.

In some examples of the method, apparatuses, and non-transitory computer-readable medium described herein, the energy storage component includes a capacitor or a battery, or both.

In some examples of the method, apparatuses, and non-transitory computer-readable medium described herein, the control message indicates a power capacity, a power density, a cycle life, a duty cycle, a maximum recharging current, a fast charging time, a charge efficiency, a standard discharge current, a maximum discharge current, a self-discharge rate, a cut-off voltage, a supported charge mode, a capability to deep discharge, temperature effects, or any combination thereof, of the energy storage component.

In some examples of the method, apparatuses, and non-transitory computer-readable medium described herein, the control message indicates a capacitance, a working voltage, a leakage current, a tolerance, a temperature coefficient, a polarization, or any combination thereof, of the energy storage component.

A method for wireless communications at a network entity is described. The method may include receiving a control message indicating a capability of an energy harvesting device to use one or more energy sources for energy harvesting, transmitting, in accordance with the capability indicated in the control message, control signaling indicating one or more parameters associated with the energy harvesting, transmitting, during an energy harvesting measurement window, an energy harvesting signal in accordance with the one or more parameters, and receiving an energy harvesting report indicating one or more energy harvesting measurements and an efficiency metric for the energy harvesting from at least one of the one or more energy sources during the energy harvesting measurement window.

An apparatus for wireless communications at a network entity is described. The apparatus may include a processor, memory coupled with the processor, and instructions stored in the memory. The instructions may be executable by the processor to cause the apparatus to receive a control message indicating a capability of an energy harvesting device to use one or more energy sources for energy harvesting, transmit, in accordance with the capability indicated in the control message, control signaling indicating one or more parameters associated with the energy harvesting, transmit, during an energy harvesting measurement window, an energy harvesting signal in accordance with the one or more parameters, and receive an energy harvesting report indicating one or more energy harvesting measurements and an efficiency metric for the energy harvesting from at least one of the one or more energy sources during the energy harvesting measurement window.

Another apparatus for wireless communications at a network entity is described. The apparatus may include means for receiving a control message indicating a capability of an energy harvesting device to use one or more energy sources for energy harvesting, means for transmitting, in accordance with the capability indicated in the control message, control signaling indicating one or more parameters associated with the energy harvesting, means for transmitting, during an energy harvesting measurement window, an energy harvesting signal in accordance with the one or more parameters, and means for receiving an energy harvesting report indicating one or more energy harvesting measurements and an efficiency metric for the energy harvesting from at least one of the one or more energy sources during the energy harvesting measurement window.

A non-transitory computer-readable medium storing code for wireless communications at a network entity is described. The code may include instructions executable by a processor to receive a control message indicating a capability of an energy harvesting device to use one or more energy sources for energy harvesting, transmit, in accordance with the capability indicated in the control message, control signaling indicating one or more parameters associated with the energy harvesting, transmit, during an energy harvesting measurement window, an energy harvesting signal in accordance with the one or more parameters, and receive an energy harvesting report indicating one or more energy harvesting measurements and an efficiency metric for the energy harvesting from at least one of the one or more energy sources during the energy harvesting measurement window.

In some examples of the method, apparatuses, and non-transitory computer-readable medium described herein, receiving the control message may include operations, features, means, or instructions for receiving the control message indicating the capability of the energy harvesting device to use a solar-based energy source, a radio frequency-based energy source, a wind-based energy source, a thermal-based energy source, or any combination thereof, for the energy harvesting.

In some examples of the method, apparatuses, and non-transitory computer-readable medium described herein, transmitting the control signaling may include operations, features, means, or instructions for transmitting the control signaling indicating the one or more parameters that identifies a duty cycle parameter for an energy harvesting signal, where the energy harvesting signal may be transmitted in accordance with the duty cycle parameter.

In some examples of the method, apparatuses, and non-transitory computer-readable medium described herein, the energy harvesting report identifies the efficiency metric for one energy source of the one or more energy sources based on the one energy source having a highest efficiency metric among the one or more energy sources during the energy harvesting measurement window.

In some examples of the method, apparatuses, and non-transitory computer-readable medium described herein, receiving the energy harvesting report may include operations, features, means, or instructions for receiving the energy harvesting report indicating the one or more energy harvesting measurements that identifies a respective efficiency of each energy source of the one or more energy sources during the energy harvesting measurement window.

In some examples of the method, apparatuses, and non-transitory computer-readable medium described herein, receiving the energy harvesting report may include operations, features, means, or instructions for receiving the energy harvesting report periodically, where the one or more parameters indicate a periodicity for the energy harvesting report.

Some examples of the method, apparatuses, and non-transitory computer-readable medium described herein may further include operations, features, means, or instructions for transmitting a grant scheduling a resource for the energy harvesting report, where the energy harvesting report may be transmitted using the resource.

### BRIEF DESCRIPTION OF THE DRAWINGS

FIG. 1 illustrates an example of a wireless communications system that supports energy harvesting capability report for ambient energy harvesting devices in accordance with one or more aspects of the present disclosure.

FIG. 2 illustrates an example of a network architecture that supports energy harvesting capability report for ambient energy harvesting devices in accordance with one or more aspects of the present disclosure.

FIG. 3 illustrates an example of a wireless communications system that supports energy harvesting capability report for ambient energy harvesting devices in accordance with one or more aspects of the present disclosure.

FIG. 4 illustrates an example of a measurement window configuration that supports energy harvesting capability report for ambient energy harvesting devices in accordance with one or more aspects of the present disclosure.

FIG. 5 illustrates an example of a process flow that supports energy harvesting capability report for ambient energy harvesting devices in accordance with one or more aspects of the present disclosure.

FIGS. 6 and 7 illustrate block diagrams of devices that support energy harvesting capability report for ambient energy harvesting devices in accordance with one or more aspects of the present disclosure.

FIG. 8 illustrates a block diagram of a communications manager that supports energy harvesting capability report for ambient energy harvesting devices in accordance with one or more aspects of the present disclosure.

FIG. 9 illustrates a diagram of a system including a device that supports energy harvesting capability report for ambient energy harvesting devices in accordance with one or more aspects of the present disclosure.

FIGS. 10 and 11 illustrate block diagrams of devices that support energy harvesting capability report for ambient energy harvesting devices in accordance with one or more aspects of the present disclosure.

FIG. 12 illustrates a block diagram of a communications manager that supports energy harvesting capability report for ambient energy harvesting devices in accordance with one or more aspects of the present disclosure.

FIG. 13 illustrates a diagram of a system including a device that supports energy harvesting capability report for ambient energy harvesting devices in accordance with one or more aspects of the present disclosure.

FIGS. 14 through 16 illustrate flowcharts showing methods that support energy harvesting capability report for ambient energy harvesting devices in accordance with one or more aspects of the present disclosure.

### DETAILED DESCRIPTION

A wireless communications system may support wireless power transfer and energy harvesting. For example, an energy harvesting device, such as a radiofrequency identification (RFID) tag, can harvest energy over the air and power transmission and reception circuitry, such as to transmit a signal using backscatter modulation. Some energy harvesting devices may harvest energy from different sources, such as a dedicated radio frequency source, an ambient radio frequency source, or environmental conditions such as solar energy. Additionally, an energy harvesting device may have external energy assistance, energy storage components, or both, which may affect energy harvesting performance and minimum sensitivity requirements to perform certain operations (e.g., read and write operations). If an energy transfer device, such as an energy transfer device, such as an RFID reader or a network entity, is not aware of the different capabilities of an energy harvesting device, the energy transfer device may consume too much power to transmit an energy harvesting signal or transmit the energy harvesting signal with insufficient power for the energy harvesting device to perform certain operations.

The present disclosure provides techniques for an energy harvesting device to transmit a capability report indicating the capabilities of the energy harvesting device. For example, the capability report may indicate energy sources supported by the energy harvesting device, such as solar-based sources, radio frequency-based sources, thermal-based sources, wind-based sources, and the like. The capability report may indicate whether the energy harvesting device has an external energy assistant for performing different operations as well as sensitivity thresholds for performing the operations while using the external energy assistant. In some examples, the capability report may indicate different characteristics or parameters of an energy storage component of the energy harvesting device, such as a battery or capacitor of the energy harvesting device. In some examples, the energy harvesting device may transmit an energy harvesting report indicating energy harvesting accessibility or efficiencies for each of the sources. In some examples, the energy harvesting device may be configured with an energy harvesting measurement window, and the energy harvesting device may perform energy harvesting measurements during the energy harvesting measurement window. The energy harvesting report may indicate an efficiency metric such as, for example, a highest efficiency between the energy sources, an average efficiency of each of the energy sources, or a highest observed efficiency of all of the energy sources during the measurement window.

Aspects of the disclosure are initially described in the context of wireless communications systems. Aspects of the disclosure are further illustrated by and described with reference to apparatus diagrams, system diagrams, and flowcharts that relate to energy harvesting capability report for ambient energy harvesting devices.

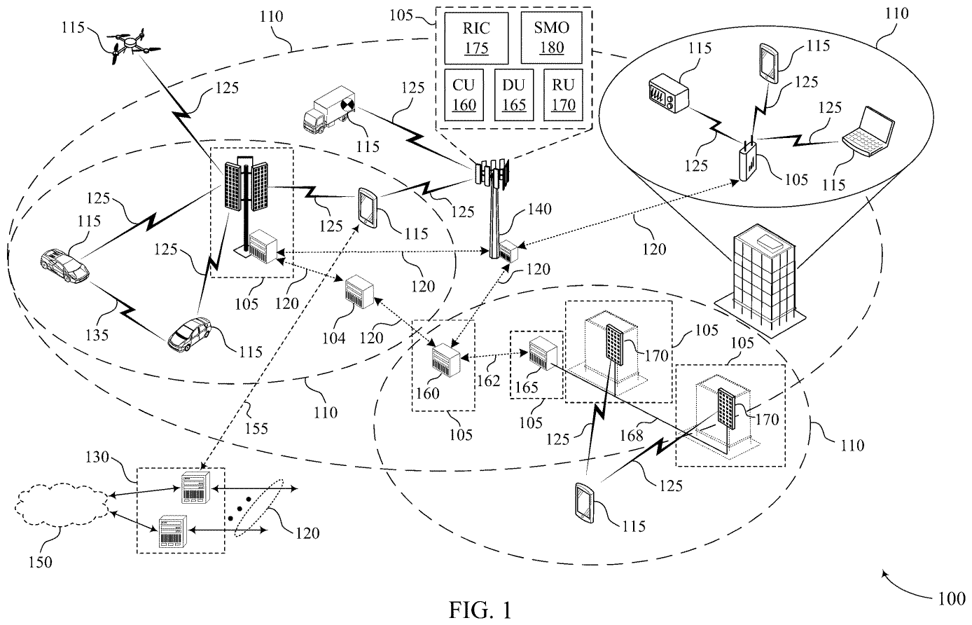

FIG. 1 illustrates an example of a wireless communications system 100 that supports energy harvesting capability report for ambient energy harvesting devices in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUS 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol).

Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support energy harvesting capability report for ambient energy harvesting devices as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, the wireless communications system 100 may support RFID technologies. RFID technology may be utilized for inventory and asset management, IoT, sustainable sensor networks in factories and/or agriculture, and smart home scenarios, among other example use cases. RFID may include relatively small transponders, or tags (e.g., microchips), that may emit an information-bearing signal upon receiving a signal. RFID may be operated with or without a batter at the RFID device and with relatively low operating cost (OPEX), relatively low maintenance cost, and a relatively long life circle.

In some implementations, the wireless communications system 100 may include one or more ambient or passive devices. Ambient devices may include, but are not limited to, RFID tags, passive IoT devices or ambient IoT devices, hybrid devices including passive and active components, passive components of otherwise active/querying devices (e.g., passive components of a UE 115), or any combination thereof. For example, in some implementations, a UE 115 of the wireless communications system 100 may serve as a passive device or an ambient device. A passive RFID may harvest energy over the air and may power transmission and reception circuitry at the device using the harvested energy. The transmitted signal by the passive RFID may be backscatter modulated. In some examples, the wireless communications system 100 may include one or more semi-passive or active RFID devices, which may include a battery, but may be more costly than ambient devices.

The wireless communications system 100 may support ambient IoT communications for different types of wireless communications (e.g., different industrial verticals, including URLLC, MTC, and other use cases). However, some systems may not efficiently support RFID-type sensors, including ambient IoT devices for use cases including asset management, logistics, warehousing, and manufacturing, among other examples. Techniques for managing and communicating with ambient IoT devices may be beneficial. For example, a network entity 105 may read or write information stored on a ambient IoT device, may provide energy to the ambient IoT device, may receive a reflected information bearing signal, and may decode information transmitted by ambient IoT devices by reading the reflected signal.

The wireless communications system 100 may use wireless power transfer for various scenarios. For example, the wireless communications system may support, or include aspects of, a wireless power transfer-based wireless sensor network, which may not need manual batter replacement due to devices being powered by one or more different energy sources (e.g., solar power, ambient radio frequency power, etc.). Additionally, a wireless power transfer-based wireless sensor network may have a longer lifetime than a solely battery-based sensor network. The wireless communications system 100 may support, or include aspects of, wireless power transfer-based active RFID, which may provide increased range for RFID signaling, and where energy can be gathered over a longer duration than information transfer. In some examples, the wireless communications system 100 may support, or include aspects of, wireless power transfer-enabled devices, which may harvest energy from hybrid energy sources, or harvesting energy from two or more energy sources.

Different types of IoT devices or ambient-IoT devices may have different energy harvesting capabilities. For example, a first energy harvesting device may support energy harvesting using a solar-based energy source while a second energy harvesting devices does not support using the solar-based energy source. It may be beneficial for a network entity 105 to be aware of the capabilities of different energy harvesting devices for the network entity 105 to perform efficient scheduling and communication. In some examples, the network entity 105 may need to know whether to provide energy to the device or not. For example, if an energy harvesting source of an energy harvesting device is solar-based, the network entity 105 may avoid scheduling communication with the energy harvesting device at night. However, current systems do not provide for an energy harvesting device to indicate supported energy harvesting capabilities.

Wireless communications systems described herein, such as the wireless communications system 100, support an energy harvesting device, such as a UE 115, an ambient IoT device, or an RFID tag, to report energy harvesting capabilities. For example, the energy harvesting device may transmit a capability report indicating energy sources supported by the energy harvesting device, such as solar-based sources, radio frequency-based sources, thermal-based sources, wind-based sources, and the like. Additionally, or alternatively, the capability report may indicate whether the energy harvesting device has an external energy assistant for performing different operations as well as sensitivity thresholds for performing the operations while using the external energy assistant. In some examples, the capability report may indicate different characteristics or parameters of an energy storage component of the energy harvesting device, such as a battery or capacitor of the energy harvesting device. In some examples, the energy harvesting device may transmit an energy harvesting report indicating energy harvesting accessibility or efficiencies for each of the sources. In some examples, the energy harvesting device may be configured with an energy harvesting measurement window, and the energy harvesting device may perform energy harvesting measurements during the energy harvesting measurement window. The energy harvesting report may indicate an efficiency metric such as, for example, a highest efficiency between the energy sources, an average efficiency of each of the energy sources, or a highest observed efficiency of all of the energy sources during the measurement window.

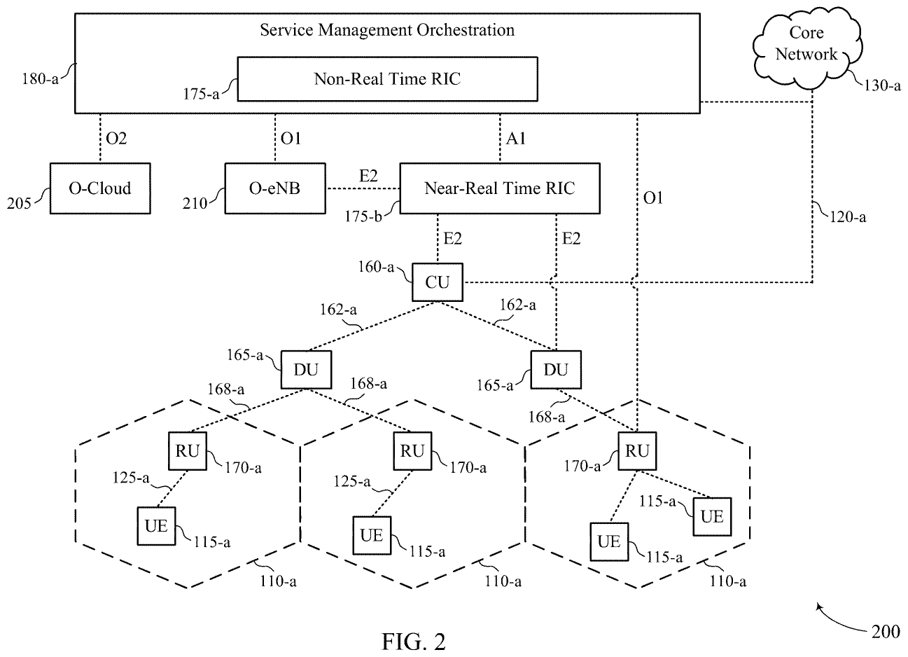

FIG. 2 illustrates an example of a network architecture 200 (e.g., a disaggregated base station architecture, a disaggregated RAN architecture) that supports energy harvesting capability report for ambient energy harvesting devices in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an El interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an Al interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., Al policies).

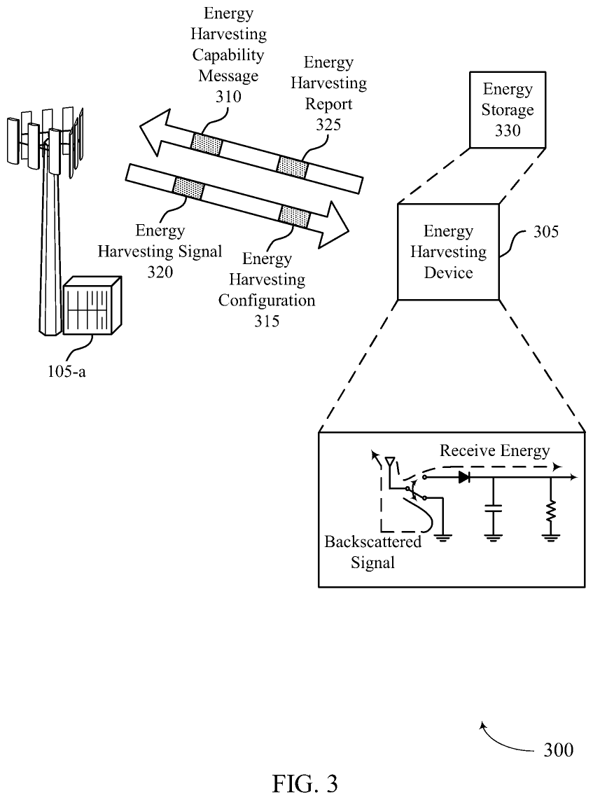

FIG. 3 illustrates an example of a wireless communications system 300 that supports energy harvesting capability report for ambient energy harvesting devices in accordance with one or more aspects of the present disclosure. The wireless communications system 300 may implement aspects of the wireless communications system 100 or the network architecture 200, or both.

The wireless communications system 300 may include a network entity 105-a and an energy harvesting device 305. The network entity 105-a may be an example of a network entity 105 as described with reference to FIGS. 1 and 2. In some examples, the network entity 105-a may be an example of an energy transfer device or an RFID reader. In some other examples, a UE 115 may be an example of the wireless power transfer device or the RFID reader. The energy harvesting device 305 may be an example of a UE 115 as described with reference to FIGS. 1 and 2. In some examples, the energy harvesting device 305 may be an example of a passive IoT device, an ambient IoT device, a semi-passive IoT device, an active IoT device, or an RFID tag, or any combination thereof.

The wireless communications system 300 may support for the energy harvesting device 305 to report energy harvesting capabilities to the network entity 105-a. Different energy harvesting devices may have different energy harvesting capabilities. If the different energy harvesting devices report the respective energy harvesting capabilities, the network entity 105-a may efficiently schedule energy harvesting signaling and communications for the different energy harvesting devices.

The energy harvesting device 305 may transmit an energy harvesting capability message 310 to the network entity 105-a. The energy harvesting capability message 310 may indicate one or more energy harvesting capabilities of the energy harvesting device 305. The energy harvesting capability message 310 may indicate supported energy sources of the energy harvesting device 305, sensitivity thresholds for different operations of the energy harvesting device 305, and the presence of, or characteristics of, an energy storage component of the energy harvesting device 305, or any combination thereof.

For example, the energy harvesting capability message 310 may indicate one or more supported energy sources of the energy harvesting device 305, which the energy harvesting device 305 may use for energy harvesting. There may be multiple ambient energy sources accessible in the environment for harvesting or mining energy. In some examples, the energy harvesting device 305 may use a solar-based source. Solar energy may be available during the day but may not be available at night. In some examples, if the energy harvesting device 305 reports support to use a solar-based energy source, the network entity 105-a may schedule the energy harvesting device 305 frequency in the daytime and may avoid schedule the energy harvesting device 305 at night. Additionally, or alternatively, the energy harvesting device 305 may use a radio frequency-based energy source. In some examples, the energy harvesting capability message 310 may indicate whether a radio frequency-based energy source is a dedicated radio frequency-based energy source or not. Additionally, or alternatively, the energy harvesting device 305 may use a thermal-based source, such as by using heat of the environment to provide power to the energy harvesting device 305. Additionally, or alternatively, the energy harvesting device 305 may use a wind-based source. In some examples, the energy harvesting capability message 310 may indicate support for any one or more of these energy sources, among others.

Different types of energy sources may have different power densities. In some examples, the network entity 105-a may determine a duty cycle for a wireless power transfer signal or an energy harvesting signal based on the reported energy sources for the energy harvesting device 305.

In some examples, the energy harvesting device 305 may indicate sensitivity thresholds for different operations of the energy harvesting device 305. For example, the energy harvesting capability message 310 may indicate the sensitivity thresholds for the different operations. Some examples of operations may include a read operation (e.g., where the energy harvesting device receives information signaling) or a write operation (e.g., where the energy harvesting device sends information using backscatter modulation).

Additionally, or alternatively, the energy harvesting capability message 310 may indicate whether the energy harvesting device 305 has external energy assistance. External energy assistance may, for example, come from a separate energy storage component or an energy source. In some examples, the energy harvesting capability message 310 may indicate whether the energy harvesting device 305 has external energy assistance for each operation, or whether the energy harvesting device 305 has external energy assistance for any operation.

The energy harvesting capability message 310 may indicate that the energy harvesting device 305 does not have external energy assistance. In some examples, the energy harvesting device 305 may have external energy assistance, but the energy harvesting capability message 310 may indicate that the energy harvesting device 305 may not support external energy assistance for certain operations.

In some examples, the energy harvesting capability message 310 may indicate that external energy can be used to assist an operation. The energy harvesting device 305 may divide available external energy into different energy levels and map different external energy levels into different sensitivity modes. The energy harvesting capability message 310 may indicate the different external energy levels and different sensitivity modes for each operations. In some examples, the energy harvesting capability message 310 may indicate whether the sensitivity modes are configurable or not.

The energy harvesting capability message 310 may indicate whether the external energy is controllable. For example, at a first time (e.g., t₁), the device may use X₁% of external energy (e.g., Y₁ μJ Energy/Z₁ μW Power) to assist the operation, and where μW is micro-Watts. At a second time (e.g., t_{N}), the device may use X_{N}% of external energy (e.g., Y_{N} μJ Energy/Z_{N} μW Power) to assist the operation. The energy harvesting device 305 may indicate conditions for selecting a level of external energy assistance, such has traffic priority or latency requirements. For example, for higher priority signaling, the energy harvesting device 305 may use a large amount or percent of external energy than for lower priority signaling.

In some examples, the energy harvesting device 305 may indicate (e.g., via the energy harvesting capability message 310) both supported external energy levels and sensitivity thresholds. In some examples, the operation of different levels of external energy assistance may correspond to different sensitivity thresholds. For example, if a first operation has a higher sensitivity threshold, such that the energy harvesting device 305 must receive a stronger energy harvesting signal to perform the operation, the energy harvesting device may use a larger amount or percent of external energy. In some examples, operations with different external energy assistance may correspond to a same sensitivity threshold. In some examples, operations with the same external energy assistance may correspond to a same sensitivity threshold. In some examples, operations with the same external energy assistance may correspond to different sensitivity thresholds.

The energy harvesting capability message 310 may indicate whether the energy harvesting device 305 supports or has an energy storage 330. If the energy harvesting device 305 has the energy storage 330, the energy harvesting capability message 310 may indicate whether the energy storage 330 is capacitor-based or battery-based. In some examples, the energy storage 330 may be referred to as an external energy component or an external energy source, or both.

If the energy harvesting device 305 supports or has an energy storage 330, the energy harvesting capability message 310 may indicate characteristics of the energy storage 330. For example, if the energy storage 330 is a battery, the energy harvesting capability message 310 may indicate a power capacity of the battery. The power capacity may refer to an amount of energy, or a current as the voltage of the battery may be fixed, that the battery can deliver while charged or discharged. In some examples, the energy harvesting capability message 310 may indicate a power density of the battery. The power density may refer to a power than can be derived per unit weight of the cell (e.g., weight per kilogram). In some examples, the energy harvesting capability message 310 may indicate a cycle life of the battery. For example, the cycle life of a rechargeable battery may refer to a quantity of discharge and charge cycles the battery can undergo before the battery capacity falls below a threshold (e.g., 80% of maximum battery capacity). In some examples, the energy harvesting capability message 310 may indicate a duty cycle of the battery. Indicating the duty cycle of the battery may indicate a quantity of energy per cycle, such that the network entity 105-a can schedule the energy harvesting device 305 for maximum energy throughput and power delivery.

In some examples, the energy harvesting capability message 310 may indicate a maximum recharging current, a fast charging time, or a charge efficiency, or any combination thereof, of the battery. In some examples, the energy harvesting capability message 310 may indicate a standard discharge current, a maximum discharge current, or a self-discharge rate. The discharge current may refer to a current that can be drawn from the battery and delivered to the load. The self-discharge rate may refer to a measure of how quickly the battery cell loses energy while sitting on a shelf due to chemical actions within the battery cell.

In some examples, the energy harvesting capability message 310 may indicate a cut-off voltage of the battery. The cut-off voltage may refer to a voltage at which the battery can be considered fully discharged. When the voltage of the battery goes below the cut-off voltage, drawing additional charge from the battery may damage the battery or lower battery life. In some examples, the energy harvesting capability message 310 may indicate supported charge modes of the battery, such as continuous charging, pulse charging, float charging, IUI charging, or random charging.

In some examples, the energy harvesting capability message 310 may indicate a capability of the battery to perform deep discharging. There may be a logarithmic relationship between the depth of discharge and the life of the battery, such that the life of the battery is increased if the battery is not fully discharged. For example, a mobile phone battery may last several times longer if the mobile phone battery is only discharged 80% before recharging instead of completely discharging. In some examples, the energy harvesting capability message 310 may indicate temperature effects to the battery. For example, the rate of chemical reactions in the battery which cause current leakage between positive and negative electrodes of the cell may increase with temperature, thus increasing the battery self-discharge rate.

If the energy storage 330 is a capacitor or a capacitor-based energy storage component, the energy harvesting capability message 310 may indicate characteristics of the capacitor or capacitor-based energy storage component. In some examples, the energy harvesting capability message 310 may indicate a capacitance of the capacitor. The capacitance may denote how many units of charge can be stored in the capacitor per voltage unit. In some examples, the energy harvesting capability message 310 may indicate a working voltage of the capacitor. The working voltage may correspond to a maximum continuous voltage (in alternating current or direct current) that can be applied to the capacitor without the capacitor failing. In some examples, the energy harvesting capability message 310 may indicate a leakage current. Leakage current may occur due to electrons physically moving through the dielectric medium, around the edges or across the leads which will over time fully discharge the capacitor if the supply voltage is removed. In some examples, the energy harvesting capability message 310 may indicate a tolerance value that identifies an extent to which actual capacitance is allowed to vary from its nominal value. In some examples, the energy harvesting capability message 310 may indicate a temperature coefficient of the capacitor. The temperature coefficient of a capacitor may be the maximum change in capacitance over a specified temperature range. In some examples, the energy harvesting capability message 310 may indicate a polarization of the capacitor. An incorrect polarization may lead to breakdown of the oxide layer inside of the capacitor, which may result in large currents flowing through the device.

The network entity 105-a may receive the energy harvesting capability message 310 from the energy harvesting device 305 and schedule the energy harvesting device 305 or energy harvesting or communications based on the capabilities of the energy harvesting device. The network entity 105-a may transmit an energy harvesting configuration 315 indicating one or more parameters associated with energy harvesting. The parameters may be, for example, one or more of a duty cycle for energy harvesting, a duration in time of a measurement window, a periodicity over which the measurement window occurs, which one or more energy harvesting sources to use for performing energy harvesting (e.g., during the measurement window), a sensitivity threshold for performing one or more operations (e.g., read and/or write) while using an external energy assistant, a sensitivity mode, an external energy level, a mapping between a sensitivity mode and an external energy level for an external energy assistant, or the like. For example, if the energy harvesting device 305 uses a solar-based energy source, the network entity 105-a may schedule the energy harvesting device 305 for communications during the day instead of at night. Similarly, if the network entity 105-a transmits signaling to the energy harvesting device 305 to configure the energy harvesting device 305 to perform an operation (e.g., a read operation or a write operation), the network entity 105-a may transmit an energy harvesting signal based on the sensitivity threshold of that operation and whether the energy harvesting device 305 can use external energy assistance to perform the operation. For example, the network entity 105-a may transmit the energy harvesting signal with a higher or lower power output based on the sensitivity threshold and whether the energy harvesting device 305 can use external energy assistance.

In some examples, the energy harvesting device 305 may perform an energy harvesting measurement during a measurement window. For example, the energy harvesting device 305 may measure energy harvesting or energy harvesting efficiency associated with one or more energy sources of the energy harvesting device 305. In some examples, the network entity 105-a may transmit an energy harvesting signal 320 to the energy harvesting device 305, and the energy harvesting device 305 may perform an energy harvesting procedure based on the energy harvesting configuration 315 to obtain one or more energy harvesting measurements. The energy harvesting device 305 may transmit an energy harvesting report 325 to the network entity 105-a indicating the one or more energy harvesting measurements. In some examples, the energy harvesting report 325 may indicate an efficiency metric for the energy harvesting from at least one of the energy sources of the energy harvesting device 305 during the energy harvesting measurement window.

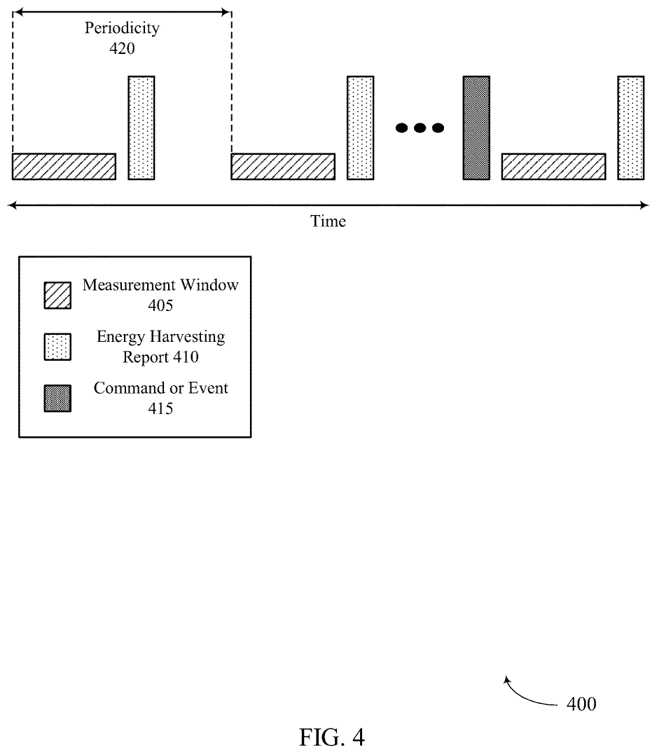

In some examples, the network entity 105-a may configure the energy harvesting device 305 to perform the energy harvesting measurement during the measurement window. For example, the network entity 105-a may configure period energy harvesting measurement windows at the energy harvesting device 305, or the network entity 105-a may dynamically schedule an energy harvesting measurement window via control signaling. Additionally, or alternatively, the energy harvesting device 305 may detect a trigger to perform an energy harvesting measurement during the energy harvesting measurement window. Some examples of an energy harvesting window are described in more detail with reference to FIG. 4.

FIG. 4 illustrates an example of a measurement window configuration 400 that supports energy harvesting capability report for ambient energy harvesting devices in accordance with one or more aspects of the present disclosure.

An energy harvesting device, such as a UE 115, RFID tag, ambient IoT device, or passive IoT device, may support one or more energy sources for energy harvesting operations. The energy harvesting device may transmit a control message indicating capabilities of the energy harvesting device for energy harvesting operations. For example, the energy harvesting device may indicate whether one or more energy sources are supported for energy harvesting. In some examples, the energy harvesting device may report energy harvesting accessibility for each supported energy source.

For example, the energy harvesting device may perform an energy harvesting procedure during a measurement window 405 (e.g., time duration). In some examples, the measurement window 405 may be referred to as an energy harvesting measurement window. The energy harvesting device may produce one or more energy harvesting measurements during the measurement window. In some examples, the energy harvesting device may obtain energy harvesting measurements for different energy sources of the energy harvesting device. For example, the energy harvesting device may measure an energy harvesting metric for a first energy source during the measurement window, and the energy harvesting device may measure the energy harvesting metric for a second energy source during the measurement window. In some examples, the energy harvesting device may measure a harvested power for a solar-based energy source and a harvested power for an ambient radio frequency-based energy source during the measurement window.

The energy harvesting device may transmit an energy harvesting report 410 to a network entity 105 indicating the one or more measurements. In some examples, the energy harvesting device may transmit the energy harvesting report 410 to the network entity 105 or an RFID reader.

In some examples, the energy harvesting report 410 may indicate an efficiency metric such as, for example, a highest harvested power, a highest harvested energy, or a highest harvested conversion efficiency among the energy sources during the measurement window 405, or any combination thereof. For example, the energy harvesting device may measure harvested energy efficiency for multiple energy sources, and the energy harvesting report 410 may indicate which energy source of the multiple energy sources had the highest harvested energy efficiency during the measurement window.

In some examples, the energy harvesting report 410 may indicate energy harvesting metrics for multiple energy sources. For example, the energy harvesting report 410 may indicate the harvested power, harvested energy, or conversion efficiency, or any combination thereof, for each energy source of the energy harvesting device during the measurement window 405.

In some examples, the energy harvesting report 410 may indicate a highest value for each of the energy sources during the measurement window. For example, the energy harvesting report may indicate a highest detected harvested energy efficiency for each energy source during the window. Additionally, or alternatively, the energy harvesting report 410 may indicate an average value for each of the energy sources during the measurement window. For example, the energy harvesting report may indicate an average harvested energy efficiency for each energy source during the window based on the total harvested energy efficiency of each energy source divided by the duration of the measurement window.

In some examples, the measurement window 405 may be configured to be periodic. For example, the network entity 105 may transmit control signaling to the energy harvesting device to configure the measurement windows during time resources associated with a periodicity 420. Additionally, or alternatively, the time-frequency resources of the measurement windows may be preconfigured at the energy harvesting device.

Additionally, or alternatively, the network entity 105 may dynamically configure a measurement window 405. For example, the network entity 105 may transmit control signaling scheduling resources for an aperiodic measurement window. In some examples, the network entity 105 may configure a semi-persistent measurement window, which may be toggled (e.g., enabled or disabled) via control signaling, such as a MAC message or a MAC control element.

In some examples, the energy harvesting device may periodically transmit an energy harvesting report 410. For example, the energy harvesting device may be configured with periodic measurement windows or preconfigured with measurement windows, and the energy harvesting device may transmit the energy harvesting report 410 after each periodic measurement window. In some other examples, the network entity 105 may dynamically configure the UE 115 to transmit the energy harvesting report 410. For example, the network entity 105 may both dynamically configure the measurement window 405 and configure the energy harvesting device to transmit the energy harvesting report (e.g., allocate a time-frequency resource for transmission of the energy harvesting report). In some examples, the network entity 105 may configure periodic measurement windows but dynamically trigger the UE 115 to transmit the energy harvesting report 410.

For example, the network entity 105 may transmit a command 415 for the energy harvesting device to transmit the energy harvesting report. The energy harvesting device may perform an energy harvesting procedure during the measurement window 405 and transmit the energy harvesting report 410 in response. In some examples, the energy harvesting device may perform the energy harvesting procedure based on the command 415 or transmit the energy harvesting report 410 based on the command 415, or both.

In some examples, the energy harvesting device may transmit the energy harvesting report 410 based on an event trigger or detecting a trigger. For example, if a harvested power, harvested energy, or conversion efficiency, or any combination thereof, is less than a threshold, the energy harvesting device may report the harvested power, harvested energy, or conversion efficiency. In some examples, the energy harvesting device may detect a trigger or an event 415 and perform the energy harvesting procedure during the measurement window 405 based on the event 415. Additionally, or alternatively, the energy harvesting device may transmit the energy harvesting report 410 based on the event 415. In some examples, the energy harvesting device may be configured with different thresholds for different energy sources. Additionally, or alternatively, different energy harvesting metrics (e.g., harvested power, harvested energy, conversion efficiency, etc.) may have different thresholds.

In some examples, the network entity 105 may configure the energy harvesting device with one or more of the thresholds. For example, in response to an energy harvesting capability message, the network entity 105 may configure the energy harvesting device with the thresholds. The thresholds may be configured via RRC signaling, MAC signaling (e.g., a MAC message or a MAC control element), or dynamic control signaling (e.g., downlink control information or sidelink control information), or any combination thereof. In some examples, the energy harvesting device may be preconfigured with the thresholds.

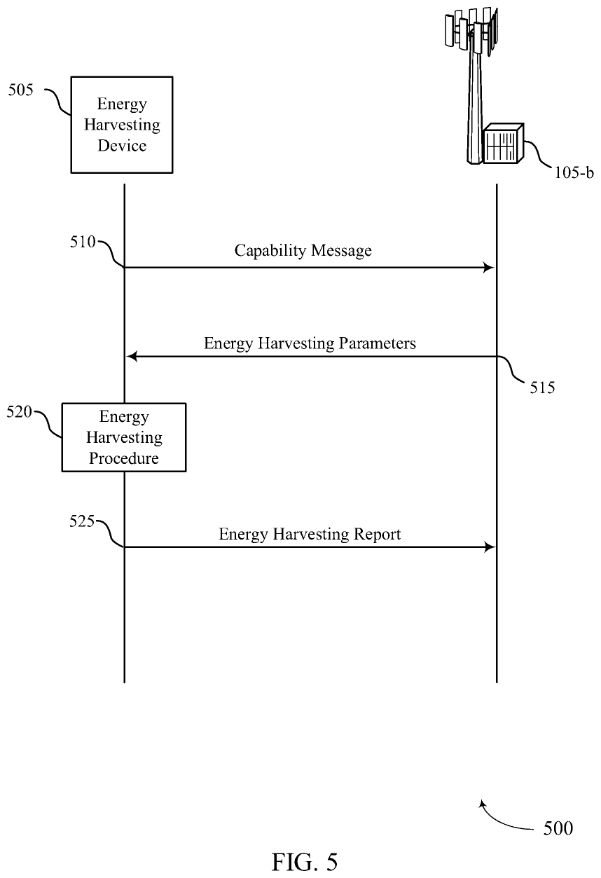

FIG. 5 illustrates an example of a process flow 500 that supports energy harvesting capability report for ambient energy harvesting devices in accordance with one or more aspects of the present disclosure. The process flow 500 may implement or be implemented by aspects of the wireless communications system 100, the network architecture 200, the wireless communications system 300, and the measurement window configuration 400 as described with reference to FIGS. 1-4. For example, the process flow 500 may include an energy harvesting device 505 and a network entity 105-b, which may represent examples of corresponding devices described herein. The process flow 500 illustrates communications between the energy harvesting device 505 and the network entity 105-b.

In the following description of the process flow 500, the operations between the energy harvesting device 505 and the network entity 105-b may be performed in different orders or at different times. Some operations may also be left out of the process flow 500, or other operations may be added. Although the energy harvesting device 505 and the network entity 105-b are shown performing the operations of the process flow 500, some aspects of some operations may also be performed by one or more other wireless devices.

At 510, the energy harvesting device 505 may transmit a capability message to the network entity 105-b. For example, the energy harvesting device 505 may transmit a control message indicating a capability of the energy harvesting device to use one or more energy sources for energy harvesting. In some examples, the control message may indicate the capability of the energy harvesting device to use a solar-based energy source, a radio frequency-based energy source, a wind-based energy source, a thermal-based energy source, or any combination thereof, for the energy harvesting.

In some examples, the control message may indicate a respective sensitivity threshold for one or more operations. For example, the control message may indicate, for each operation of the one or more operations, a first sensitivity threshold based at on using an external energy source and a second sensitivity threshold based on not using the external energy source. In some examples, the respective sensitivity threshold for the one or more operations is based on a traffic priority or a latency associated with each operation of the one or more operations. In some examples, the control message may indicate that the energy harvesting device 505 supports or has one or more external energy sources. In some examples, the control message may indicate a capability to use a variable energy draw from the one or more external energy sources. In some examples, the control message may indicate whether the energy harvesting device 505 can use a variable energy draw for one or more operations.

In some examples, the control message may indicate whether the energy harvesting device 505 has an energy storage component, such as a battery or a capacitor. If the energy harvesting device 505 has a battery as an external energy storage component, the control message may indicate a power capacity, a power density, a cycle life, a duty cycle, a maximum recharging current, a fast charging time, a charge efficiency, a standard discharge current, a maximum discharge current, a self-discharge rate, a cut-off voltage, a supported charge mode, a capability to deep discharge, temperature effects, or any combination thereof, of the energy storage component. If the energy harvesting device 505 has a capacitor as an external energy storage component, the control message may indicate a capacitance, a working voltage, a leakage current, a tolerance, a temperature coefficient, a polarization, or any combination thereof, of the energy storage component.

At 515, the network entity 105-b may indicate energy harvesting parameters to the energy harvesting device 505. For example, the network entity 105-b may transmit, in accordance with the capability indicated in the control message, control signaling indicating one or more parameters associated with the energy harvesting. In some examples, the control signaling may indicate one or more parameters that identifies a duty cycle parameter for an energy harvesting signal, a sensitivity threshold, an external energy level, or the like.

At 520, the energy harvesting device 505 may perform an energy harvesting procedure. For example, the energy harvesting device 505 may perform, during an energy harvesting measurement window, an energy harvesting procedure in accordance with the one or more parameters to produce one or more energy harvesting measurements. In some examples, the energy harvesting device 505 may determine one or more energy harvesting measurements, such as an amount of harvested energy, a harvested power, or a conversion efficiency, or any combination thereof, for one or more energy sources during the energy harvesting measurement window.

At 525, the energy harvesting device 505 may transmit an energy harvesting report to the network entity 105-b. For example, the energy harvesting device 505 may transmit an energy harvesting report indicating the one or more energy harvesting measurements and an efficiency metric for the energy harvesting from at least one of the one or more energy sources during the energy harvesting measurement window.

In some examples, the energy harvesting report may identify the efficiency metric for one energy source of the one or more energy sources based on the one energy source having a highest efficiency metric among the one or more energy sources. For example, the energy harvesting report may identify an energy source which has a highest harvested power, harvested energy, or conversion efficiency during the energy harvesting measurement window.

In some examples, the energy harvesting report may indicate the one or more energy harvesting measurements that identifies a respective efficiency of each energy source of the one or more energy sources based on performing the energy harvesting procedure. For example, the energy harvesting device 505 may report the harvested power, harvested energy, or conversion efficiency for each energy source of the energy harvesting device 505. In some examples, the energy harvesting report indicates a respective highest efficiency of each energy source during the energy harvesting measurement window. In some examples, the energy harvesting report indicates a respective average efficiency of each energy source during the energy harvesting measurement window.

In some examples, the energy harvesting device 505 may transmit the energy harvesting report periodically. For example, the control signaling indicating the one or more parameters may indicate a periodicity for the energy harvesting report. In some examples, the energy harvesting device 505 may receive (e.g., from the network entity 105-b) a grant scheduling a resource for the energy harvesting report. The energy harvesting device 505 may transmit the energy harvesting report is transmitted using the resource.

In some examples, the energy harvesting device 505 may detect a trigger to transmit the energy harvesting report. The energy harvesting device 505 may transmit the energy harvesting report based on the trigger. The trigger may be based on an efficiency of an energy source of the one or more energy sources failing to satisfy a first threshold or an energy harvesting measurement of the one or more energy harvesting measurements failing to satisfy a second threshold, or both.

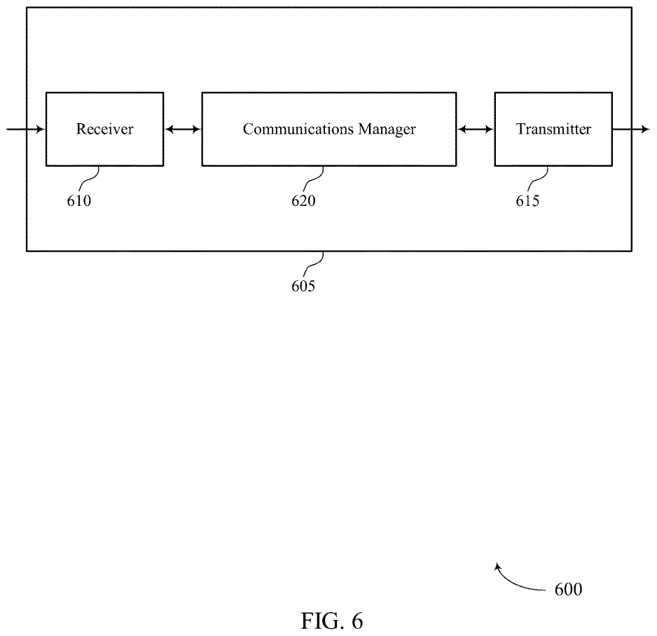

FIG. 6 illustrates a block diagram 600 of a device 605 that supports energy harvesting capability report for ambient energy harvesting devices in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to energy harvesting capability report for ambient energy harvesting devices). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to energy harvesting capability report for ambient energy harvesting devices). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of energy harvesting capability report for ambient energy harvesting devices as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at an energy harvesting device in accordance with examples as disclosed herein. For example, the communications manager 620 may be configured as or otherwise support a means for transmitting a control message indicating a capability of the energy harvesting device to use one or more energy sources for energy harvesting. The communications manager 620 may be configured as or otherwise support a means for receiving, in accordance with the capability indicated in the control message, control signaling indicating one or more parameters associated with the energy harvesting. The communications manager 620 may be configured as or otherwise support a means for performing, during an energy harvesting measurement window, an energy harvesting procedure in accordance with the one or more parameters to produce one or more energy harvesting measurements. The communications manager 620 may be configured as or otherwise support a means for transmitting an energy harvesting report indicating the one or more energy harvesting measurements and an efficiency metric for the energy harvesting from at least one of the one or more energy sources during the energy harvesting measurement window.

Additionally, or alternatively, the communications manager 620 may support wireless communications at a network entity in accordance with examples as disclosed herein. For example, the communications manager 620 may be configured as or otherwise support a means for receiving a control message indicating a capability of an energy harvesting device to use one or more energy sources for energy harvesting. The communications manager 620 may be configured as or otherwise support a means for transmitting, in accordance with the capability indicated in the control message, control signaling indicating one or more parameters associated with the energy harvesting. The communications manager 620 may be configured as or otherwise support a means for transmitting, during an energy harvesting measurement window, an energy harvesting signal in accordance with the one or more parameters. The communications manager 620 may be configured as or otherwise support a means for receiving an energy harvesting report indicating one or more energy harvesting measurements and an efficiency metric for the energy harvesting from at least one of the one or more energy sources during the energy harvesting measurement window.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for efficient scheduling of energy harvesting signaling and communications which utilize energy harvesting, such as backscatter communications.

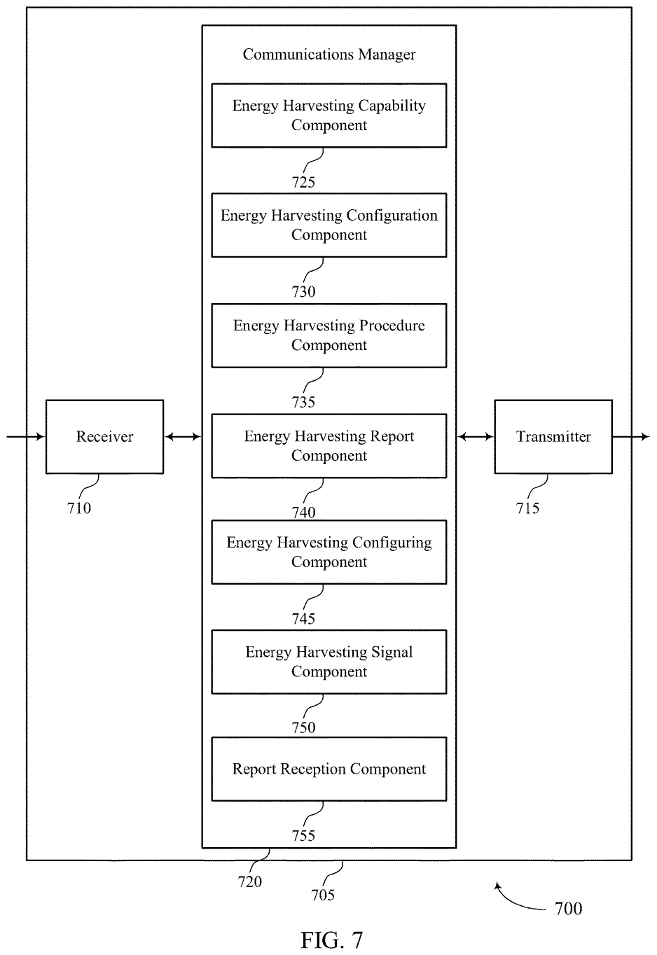

FIG. 7 illustrates a block diagram 700 of a device 705 that supports energy harvesting capability report for ambient energy harvesting devices in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to energy harvesting capability report for ambient energy harvesting devices). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to energy harvesting capability report for ambient energy harvesting devices). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of energy harvesting capability report for ambient energy harvesting devices as described herein. For example, the communications manager 720 may include an energy harvesting capability component 725, an energy harvesting configuration component 730, an energy harvesting procedure component 735, an energy harvesting report component 740, an energy harvesting configuring component 745, an energy harvesting signal component 750, a report reception component 755, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at an energy harvesting device in accordance with examples as disclosed herein. The energy harvesting capability component 725 may be configured as or otherwise support a means for transmitting a control message indicating a capability of the energy harvesting device to use one or more energy sources for energy harvesting. The energy harvesting configuration component 730 may be configured as or otherwise support a means for receiving, in accordance with the capability indicated in the control message, control signaling indicating one or more parameters associated with the energy harvesting. The energy harvesting procedure component 735 may be configured as or otherwise support a means for performing, during an energy harvesting measurement window, an energy harvesting procedure in accordance with the one or more parameters to produce one or more energy harvesting measurements. The energy harvesting report component 740 may be configured as or otherwise support a means for transmitting an energy harvesting report indicating the one or more energy harvesting measurements and an efficiency metric for the energy harvesting from at least one of the one or more energy sources during the energy harvesting measurement window.

Additionally, or alternatively, the communications manager 720 may support wireless communications at a network entity in accordance with examples as disclosed herein. The energy harvesting capability component 725 may be configured as or otherwise support a means for receiving a control message indicating a capability of an energy harvesting device to use one or more energy sources for energy harvesting. The energy harvesting configuring component 745 may be configured as or otherwise support a means for transmitting, in accordance with the capability indicated in the control message, control signaling indicating one or more parameters associated with the energy harvesting. The energy harvesting signal component 750 may be configured as or otherwise support a means for transmitting, during an energy harvesting measurement window, an energy harvesting signal in accordance with the one or more parameters. The report reception component 755 may be configured as or otherwise support a means for receiving an energy harvesting report indicating one or more energy harvesting measurements and an efficiency metric for the energy harvesting from at least one of the one or more energy sources during the energy harvesting measurement window.

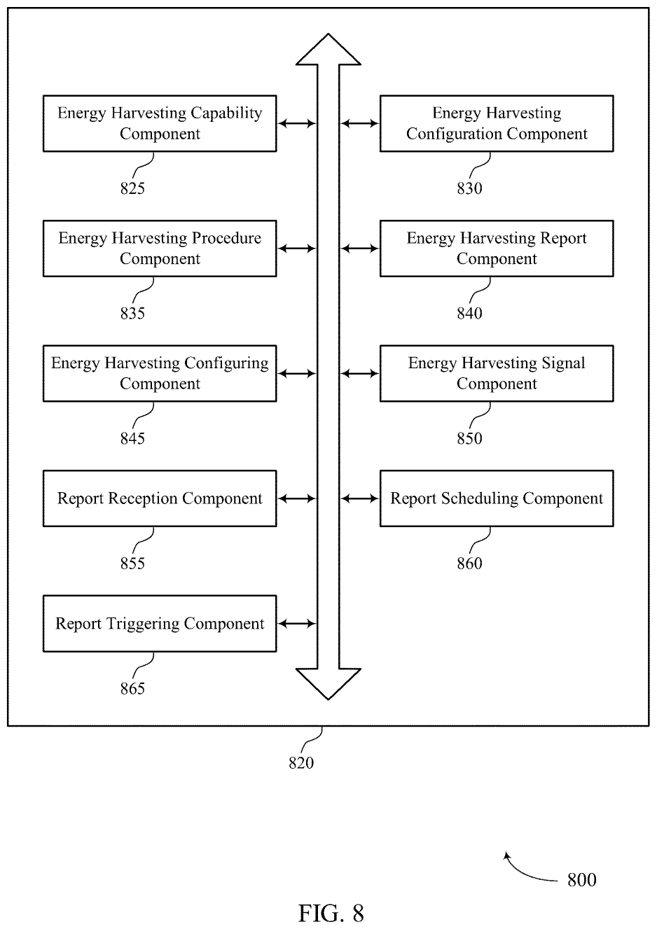

FIG. 8 illustrates a block diagram 800 of a communications manager 820 that supports energy harvesting capability report for ambient energy harvesting devices in accordance with one or more aspects of the present disclosure. The communications manager 820 may be an example of aspects of a communications manager 620, a communications manager 720, or both, as described herein. The communications manager 820, or various components thereof, may be an example of means for performing various aspects of energy harvesting capability report for ambient energy harvesting devices as described herein. For example, the communications manager 820 may include an energy harvesting capability component 825, an energy harvesting configuration component 830, an energy harvesting procedure component 835, an energy harvesting report component 840, an energy harvesting configuring component 845, an energy harvesting signal component 850, a report reception component 855, a report scheduling component 860, a report triggering component 865, or any combination thereof. Each of these components may communicate, directly or indirectly, with one another (e.g., via one or more buses).

The communications manager 820 may support wireless communications at an energy harvesting device in accordance with examples as disclosed herein. The energy harvesting capability component 825 may be configured as or otherwise support a means for transmitting a control message indicating a capability of the energy harvesting device to use one or more energy sources for energy harvesting. The energy harvesting configuration component 830 may be configured as or otherwise support a means for receiving, in accordance with the capability indicated in the control message, control signaling indicating one or more parameters associated with the energy harvesting. The energy harvesting procedure component 835 may be configured as or otherwise support a means for performing, during an energy harvesting measurement window, an energy harvesting procedure in accordance with the one or more parameters to produce one or more energy harvesting measurements. The energy harvesting report component 840 may be configured as or otherwise support a means for transmitting an energy harvesting report indicating the one or more energy harvesting measurements and an efficiency metric for the energy harvesting from at least one of the one or more energy sources during the energy harvesting measurement window.

In some examples, to support transmitting the control message, the energy harvesting capability component 825 may be configured as or otherwise support a means for transmitting the control message indicating the capability of the energy harvesting device to use a solar-based energy source, a radio frequency-based energy source, a wind-based energy source, a thermal-based energy source, or any combination thereof, for the energy harvesting.

In some examples, to support receiving the control signaling, the energy harvesting configuration component 830 may be configured as or otherwise support a means for receiving the control signaling indicating the one or more parameters that identifies a duty cycle parameter for an energy harvesting signal, where performing the energy harvesting procedure is based on the duty cycle parameter for the energy harvesting signal.

In some examples, the energy harvesting report identifies the efficiency metric for one energy source of the one or more energy sources based on the one energy source having a highest efficiency metric among the one or more energy sources.

In some examples, the efficiency metric is power harvesting efficiency, energy harvesting efficiency, conversion efficiency, or any combination thereof.

In some examples, to support transmitting the energy harvesting report, the energy harvesting report component 840 may be configured as or otherwise support a means for transmitting the energy harvesting report indicating the one or more energy harvesting measurements that identifies a respective efficiency of each energy source of the one or more energy sources based on performing the energy harvesting procedure.

In some examples, the energy harvesting report indicates a respective highest efficiency of each energy source during the energy harvesting measurement window.

In some examples, the energy harvesting report indicates a respective average efficiency of each energy source during the energy harvesting measurement window.

In some examples, to support transmitting the energy harvesting report, the energy harvesting report component 840 may be configured as or otherwise support a means for transmitting the energy harvesting report periodically, where the one or more parameters indicate a periodicity for the energy harvesting report.

In some examples, the report scheduling component 860 may be configured as or otherwise support a means for receiving a grant scheduling a resource for the energy harvesting report, where the energy harvesting report is transmitted using the resource.

In some examples, the report triggering component 865 may be configured as or otherwise support a means for detecting a trigger to transmit the energy harvesting report, where the energy harvesting report is transmitted based on the trigger.

In some examples, the trigger is based on an efficiency of an energy source of the one or more energy sources failing to satisfy a first threshold or an energy harvesting measurement of the one or more energy harvesting measurements failing to satisfy a second threshold, or both.

In some examples, the one or more parameters associated with the energy harvesting includes the first threshold or the second threshold, or both.

In some examples, the energy harvesting procedure is performed based on detecting the trigger.

In some examples, to support transmitting the control message, the energy harvesting capability component 825 may be configured as or otherwise support a means for transmitting the control message indicating a respective sensitivity threshold for one or more operations.

In some examples, the control message indicates, for each operation of the one or more operations, a first sensitivity threshold based on using an external energy source and a second sensitivity threshold based on not using the external energy source.

In some examples, the respective sensitivity threshold for the one or more operations is based on a traffic priority or a latency associated with each operation of the one or more operations.

In some examples, to support transmitting the control message, the energy harvesting capability component 825 may be configured as or otherwise support a means for transmitting the control message indicating one or more external energy sources of the energy harvesting device.

In some examples, the control message indicates support for using a variable energy draw from the one or more external energy sources.

In some examples, to support transmitting the control message, the energy harvesting capability component 825 may be configured as or otherwise support a means for transmitting the control message indicating an energy storage component of the energy harvesting device.

In some examples, the energy storage component includes a capacitor or a battery, or both.

In some examples, the control message indicates a power capacity, a power density, a cycle life, a duty cycle, a maximum recharging current, a fast charging time, a charge efficiency, a standard discharge current, a maximum discharge current, a self-discharge rate, a cut-off voltage, a supported charge mode, a capability to deep discharge, temperature effects, or any combination thereof, of the energy storage component.

In some examples, the control message indicates a capacitance, a working voltage, a leakage current, a tolerance, a temperature coefficient, a polarization, or any combination thereof, of the energy storage component.

Additionally, or alternatively, the communications manager 820 may support wireless communications at a network entity in accordance with examples as disclosed herein. In some examples, the energy harvesting capability component 825 may be configured as or otherwise support a means for receiving a control message indicating a capability of an energy harvesting device to use one or more energy sources for energy harvesting. The energy harvesting configuring component 845 may be configured as or otherwise support a means for transmitting, in accordance with the capability indicated in the control message, control signaling indicating one or more parameters associated with the energy harvesting. The energy harvesting signal component 850 may be configured as or otherwise support a means for transmitting, during an energy harvesting measurement window, an energy harvesting signal in accordance with the one or more parameters. The report reception component 855 may be configured as or otherwise support a means for receiving an energy harvesting report indicating one or more energy harvesting measurements and an efficiency metric for the energy harvesting from at least one of the one or more energy sources during the energy harvesting measurement window.

In some examples, to support receiving the control message, the energy harvesting capability component 825 may be configured as or otherwise support a means for receiving the control message indicating the capability of the energy harvesting device to use a solar-based energy source, a radio frequency-based energy source, a wind-based energy source, a thermal-based energy source, or any combination thereof, for the energy harvesting.

In some examples, to support transmitting the control signaling, the energy harvesting configuring component 845 may be configured as or otherwise support a means for transmitting the control signaling indicating the one or more parameters that identifies a duty cycle parameter for an energy harvesting signal, where the energy harvesting signal is transmitted in accordance with the duty cycle parameter.

In some examples, the energy harvesting report identifies the efficiency metric for one energy source of the one or more energy sources based on the one energy source having a highest efficiency metric among the one or more energy sources during the energy harvesting measurement window.

In some examples, to support receiving the energy harvesting report, the report reception component 855 may be configured as or otherwise support a means for receiving the energy harvesting report indicating the one or more energy harvesting measurements that identifies a respective efficiency of each energy source of the one or more energy sources during the energy harvesting measurement window.

In some examples, to support receiving the energy harvesting report, the report reception component 855 may be configured as or otherwise support a means for receiving the energy harvesting report periodically, where the one or more parameters indicate a periodicity for the energy harvesting report.

In some examples, the report scheduling component 860 may be configured as or otherwise support a means for transmitting a grant scheduling a resource for the energy harvesting report, where the energy harvesting report is transmitted using the resource.

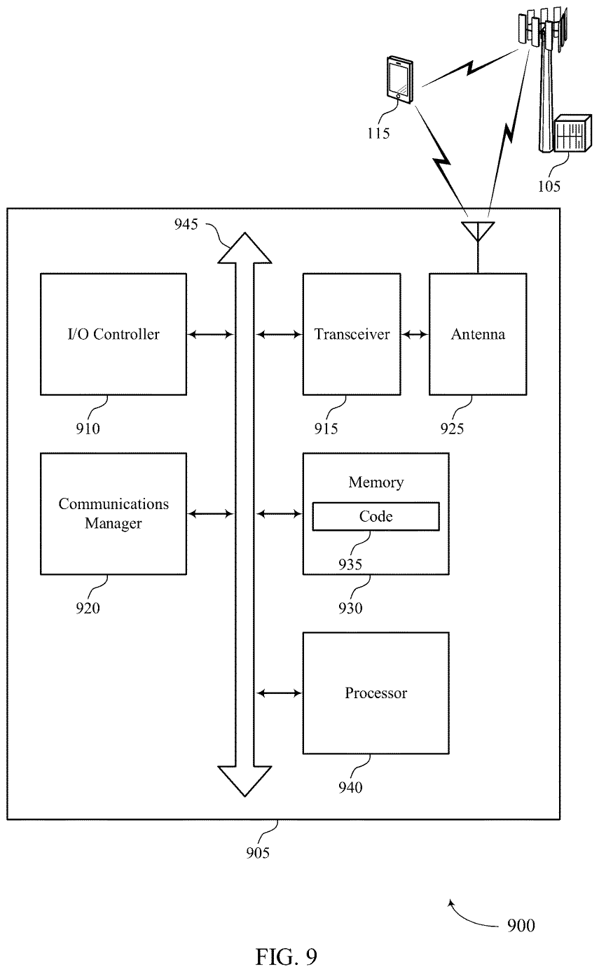

FIG. 9 illustrates a diagram of a system 900 including a device 905 that supports energy harvesting capability report for ambient energy harvesting devices in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting energy harvesting capability report for ambient energy harvesting devices). For example, the device 905 or a component of the device 905 may include a processor 940 and memory 930 coupled with or to the processor 940, the processor 940 and memory 930 configured to perform various functions described herein.

The communications manager 920 may support wireless communications at an energy harvesting device in accordance with examples as disclosed herein. For example, the communications manager 920 may be configured as or otherwise support a means for transmitting a control message indicating a capability of the energy harvesting device to use one or more energy sources for energy harvesting. The communications manager 920 may be configured as or otherwise support a means for receiving, in accordance with the capability indicated in the control message, control signaling indicating one or more parameters associated with the energy harvesting. The communications manager 920 may be configured as or otherwise support a means for performing, during an energy harvesting measurement window, an energy harvesting procedure in accordance with the one or more parameters to produce one or more energy harvesting measurements. The communications manager 920 may be configured as or otherwise support a means for transmitting an energy harvesting report indicating the one or more energy harvesting measurements and an efficiency metric for the energy harvesting from at least one of the one or more energy sources during the energy harvesting measurement window.

Additionally, or alternatively, the communications manager 920 may support wireless communications at a network entity in accordance with examples as disclosed herein. For example, the communications manager 920 may be configured as or otherwise support a means for receiving a control message indicating a capability of an energy harvesting device to use one or more energy sources for energy harvesting. The communications manager 920 may be configured as or otherwise support a means for transmitting, in accordance with the capability indicated in the control message, control signaling indicating one or more parameters associated with the energy harvesting. The communications manager 920 may be configured as or otherwise support a means for transmitting, during an energy harvesting measurement window, an energy harvesting signal in accordance with the one or more parameters. The communications manager 920 may be configured as or otherwise support a means for receiving an energy harvesting report indicating one or more energy harvesting measurements and an efficiency metric for the energy harvesting from at least one of the one or more energy sources during the energy harvesting measurement window.

By including or configuring the communications manager 920 in accordance with examples as described herein, the device 905 may support techniques for reduced power consumption and more efficient utilization of communication resources. For example, these techniques may provide for efficient scheduling of energy harvesting signaling and communications which utilize energy harvesting, such as backscatter communications.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of energy harvesting capability report for ambient energy harvesting devices as described herein, or the processor 940 and the memory 930 may be otherwise configured to perform or support such operations.

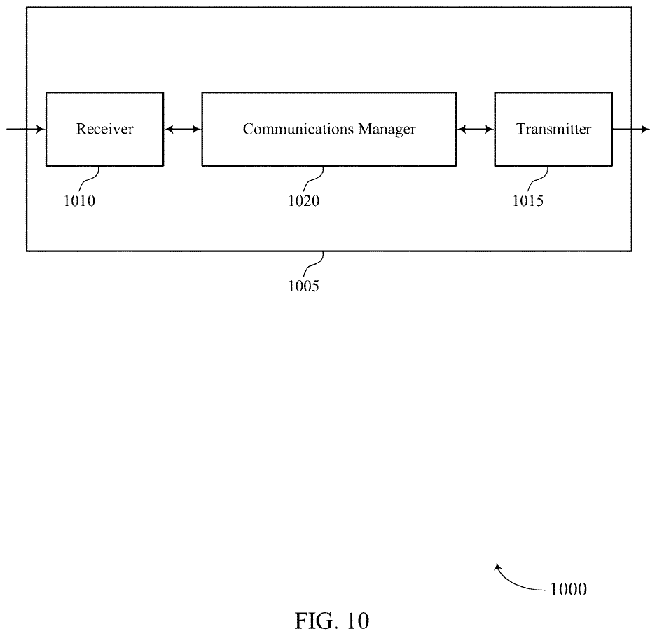

FIG. 10 illustrates a block diagram 1000 of a device 1005 that supports energy harvesting capability report for ambient energy harvesting devices in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of energy harvesting capability report for ambient energy harvesting devices as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 may be configured as or otherwise support a means for receiving a control message indicating a capability of an energy harvesting device to use one or more energy sources for energy harvesting. The communications manager 1020 may be configured as or otherwise support a means for transmitting, in accordance with the capability indicated in the control message, control signaling indicating one or more parameters associated with the energy harvesting. The communications manager 1020 may be configured as or otherwise support a means for transmitting, during an energy harvesting measurement window, an energy harvesting signal in accordance with the one or more parameters. The communications manager 1020 may be configured as or otherwise support a means for receiving an energy harvesting report indicating one or more energy harvesting measurements and an efficiency metric for the energy harvesting from at least one of the one or more energy sources during the energy harvesting measurement window.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced power consumption and more efficient utilization of communication resources. For example, these techniques may provide for efficient scheduling of energy harvesting signaling and communications which utilize energy harvesting, such as backscatter communications.

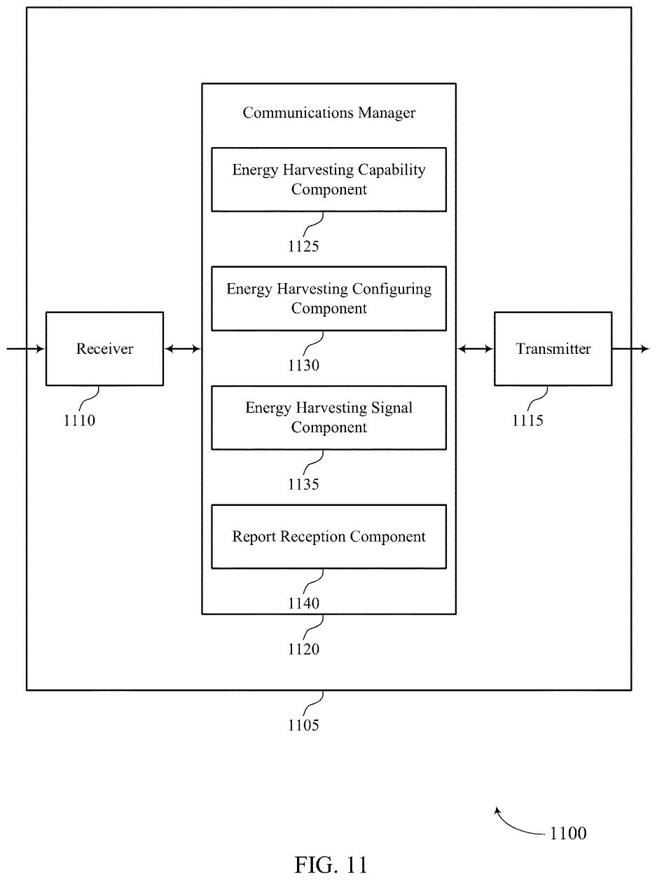

FIG. 11 illustrates a block diagram 1100 of a device 1105 that supports energy harvesting capability report for ambient energy harvesting devices in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of energy harvesting capability report for ambient energy harvesting devices as described herein. For example, the communications manager 1120 may include an energy harvesting capability component 1125, an energy harvesting configuring component 1130, an energy harvesting signal component 1135, a report reception component 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The energy harvesting capability component 1125 may be configured as or otherwise support a means for receiving a control message indicating a capability of an energy harvesting device to use one or more energy sources for energy harvesting. The energy harvesting configuring component 1130 may be configured as or otherwise support a means for transmitting, in accordance with the capability indicated in the control message, control signaling indicating one or more parameters associated with the energy harvesting. The energy harvesting signal component 1135 may be configured as or otherwise support a means for transmitting, during an energy harvesting measurement window, an energy harvesting signal in accordance with the one or more parameters. The report reception component 1140 may be configured as or otherwise support a means for receiving an energy harvesting report indicating one or more energy harvesting measurements and an efficiency metric for the energy harvesting from at least one of the one or more energy sources during the energy harvesting measurement window.

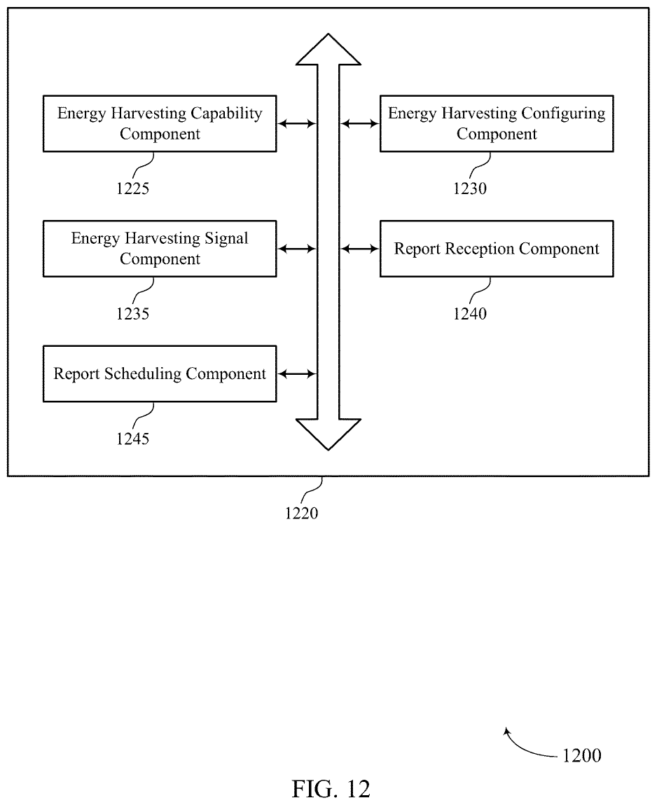

FIG. 12 illustrates a block diagram 1200 of a communications manager 1220 that supports energy harvesting capability report for ambient energy harvesting devices in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of energy harvesting capability report for ambient energy harvesting devices as described herein. For example, the communications manager 1220 may include an energy harvesting capability component 1225, an energy harvesting configuring component 1230, an energy harvesting signal component 1235, a report reception component 1240, a report scheduling component 1245, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The energy harvesting capability component 1225 may be configured as or otherwise support a means for receiving a control message indicating a capability of an energy harvesting device to use one or more energy sources for energy harvesting. The energy harvesting configuring component 1230 may be configured as or otherwise support a means for transmitting, in accordance with the capability indicated in the control message, control signaling indicating one or more parameters associated with the energy harvesting. The energy harvesting signal component 1235 may be configured as or otherwise support a means for transmitting, during an energy harvesting measurement window, an energy harvesting signal in accordance with the one or more parameters. The report reception component 1240 may be configured as or otherwise support a means for receiving an energy harvesting report indicating one or more energy harvesting measurements and an efficiency metric for the energy harvesting from at least one of the one or more energy sources during the energy harvesting measurement window.

In some examples, to support receiving the control message, the energy harvesting capability component 1225 may be configured as or otherwise support a means for receiving the control message indicating the capability of the energy harvesting device to use a solar-based energy source, a radio frequency-based energy source, a wind-based energy source, a thermal-based energy source, or any combination thereof, for the energy harvesting.

In some examples, to support transmitting the control signaling, the energy harvesting configuring component 1230 may be configured as or otherwise support a means for transmitting the control signaling indicating the one or more parameters that identifies a duty cycle parameter for an energy harvesting signal, where the energy harvesting signal is transmitted in accordance with the duty cycle parameter.

In some examples, the energy harvesting report identifies the efficiency metric for one energy source of the one or more energy sources based on the one energy source having a highest efficiency metric among the one or more energy sources during the energy harvesting measurement window.

In some examples, to support receiving the energy harvesting report, the report reception component 1240 may be configured as or otherwise support a means for receiving the energy harvesting report indicating the one or more energy harvesting measurements that identifies a respective efficiency of each energy source of the one or more energy sources during the energy harvesting measurement window.

In some examples, to support receiving the energy harvesting report, the report reception component 1240 may be configured as or otherwise support a means for receiving the energy harvesting report periodically, where the one or more parameters indicate a periodicity for the energy harvesting report.

In some examples, the report scheduling component 1245 may be configured as or otherwise support a means for transmitting a grant scheduling a resource for the energy harvesting report, where the energy harvesting report is transmitted using the resource.

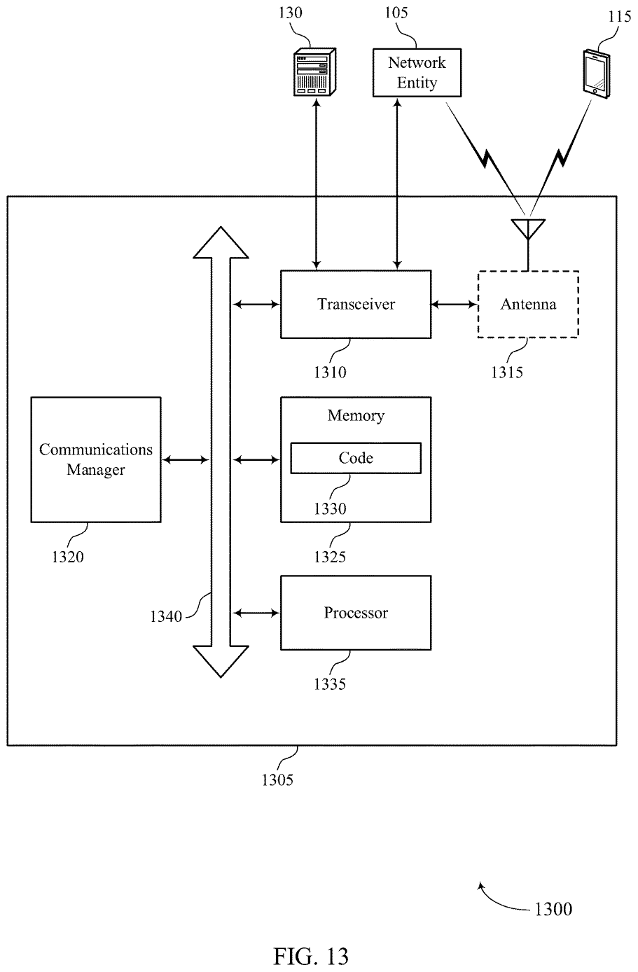

FIG. 13 illustrates a diagram of a system 1300 including a device 1305 that supports energy harvesting capability report for ambient energy harvesting devices in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting energy harvesting capability report for ambient energy harvesting devices). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity in accordance with examples as disclosed herein. For example, the communications manager 1320 may be configured as or otherwise support a means for receiving a control message indicating a capability of an energy harvesting device to use one or more energy sources for energy harvesting. The communications manager 1320 may be configured as or otherwise support a means for transmitting, in accordance with the capability indicated in the control message, control signaling indicating one or more parameters associated with the energy harvesting. The communications manager 1320 may be configured as or otherwise support a means for transmitting, during an energy harvesting measurement window, an energy harvesting signal in accordance with the one or more parameters. The communications manager 1320 may be configured as or otherwise support a means for receiving an energy harvesting report indicating one or more energy harvesting measurements and an efficiency metric for the energy harvesting from at least one of the one or more energy sources during the energy harvesting measurement window.

By including or configuring the communications manager 1320 in accordance with examples as described herein, the device 1305 may support techniques for reduced power consumption and more efficient utilization of communication resources. For example, these techniques may provide for efficient scheduling of energy harvesting signaling and communications which utilize energy harvesting, such as backscatter communications.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of energy harvesting capability report for ambient energy harvesting devices as described herein, or the processor 1335 and the memory 1325 may be otherwise configured to perform or support such operations.

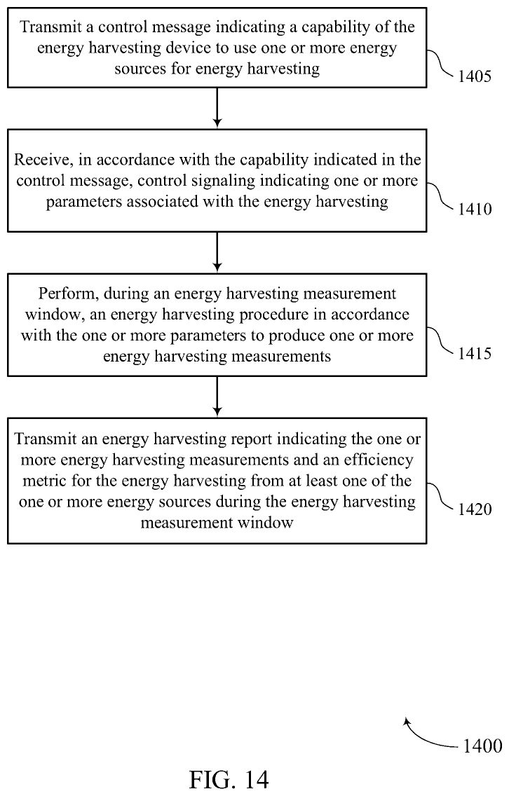

FIG. 14 illustrates a flowchart showing a method 1400 that supports energy harvesting capability report for ambient energy harvesting devices in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting a control message indicating a capability of the energy harvesting device to use one or more energy sources for energy harvesting. The operations of 1405 may be performed in accordance with examples as disclosed herein. In some examples, aspects of the operations of 1405 may be performed by an energy harvesting capability component 825 as described with reference to FIG. 8.

At 1410, the method may include receiving, in accordance with the capability indicated in the control message, control signaling indicating one or more parameters associated with the energy harvesting. The operations of 1410 may be performed in accordance with examples as disclosed herein. In some examples, aspects of the operations of 1410 may be performed by an energy harvesting configuration component 830 as described with reference to FIG. 8.

At 1415, the method may include performing, during an energy harvesting measurement window, an energy harvesting procedure in accordance with the one or more parameters to produce one or more energy harvesting measurements. The operations of 1415 may be performed in accordance with examples as disclosed herein. In some examples, aspects of the operations of 1415 may be performed by an energy harvesting procedure component 835 as described with reference to FIG. 8.

At 1420, the method may include transmitting an energy harvesting report indicating the one or more energy harvesting measurements and an efficiency metric for the energy harvesting from at least one of the one or more energy sources during the energy harvesting measurement window. The operations of 1420 may be performed in accordance with examples as disclosed herein. In some examples, aspects of the operations of 1420 may be performed by an energy harvesting report component 840 as described with reference to FIG. 8.

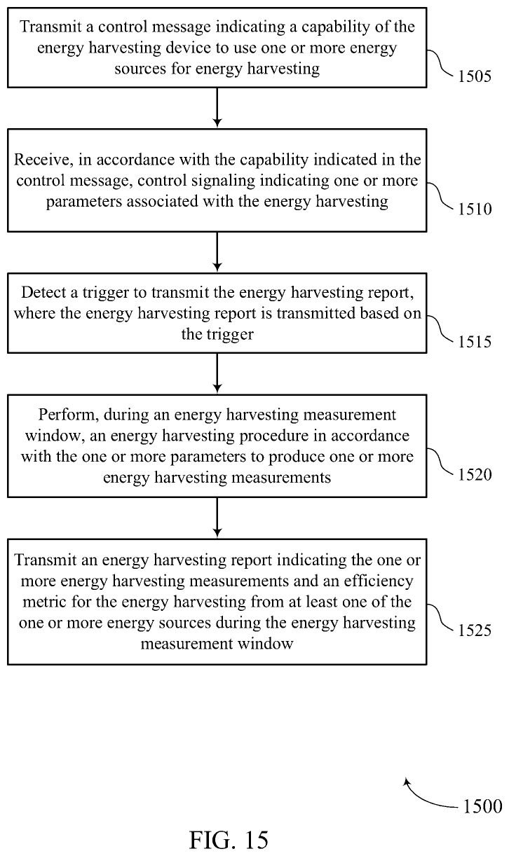

FIG. 15 illustrates a flowchart showing a method 1500 that supports energy harvesting capability report for ambient energy harvesting devices in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include transmitting a control message indicating a capability of the energy harvesting device to use one or more energy sources for energy harvesting. The operations of 1505 may be performed in accordance with examples as disclosed herein. In some examples, aspects of the operations of 1505 may be performed by an energy harvesting capability component 825 as described with reference to FIG. 8.

At 1510, the method may include receiving, in accordance with the capability indicated in the control message, control signaling indicating one or more parameters associated with the energy harvesting. The operations of 1510 may be performed in accordance with examples as disclosed herein. In some examples, aspects of the operations of 1510 may be performed by an energy harvesting configuration component 830 as described with reference to FIG. 8.

At 1515, the method may include detecting a trigger to transmit the energy harvesting report, where the energy harvesting report is transmitted based on the trigger. The operations of 1515 may be performed in accordance with examples as disclosed herein. In some examples, aspects of the operations of 1515 may be performed by a report triggering component 865 as described with reference to FIG. 8.

At 1520, the method may include performing, during an energy harvesting measurement window, an energy harvesting procedure in accordance with the one or more parameters to produce one or more energy harvesting measurements. The operations of 1520 may be performed in accordance with examples as disclosed herein. In some examples, aspects of the operations of 1520 may be performed by an energy harvesting procedure component 835 as described with reference to FIG. 8.

At 1525, the method may include transmitting an energy harvesting report indicating the one or more energy harvesting measurements and an efficiency metric for the energy harvesting from at least one of the one or more energy sources during the energy harvesting measurement window. The operations of 1525 may be performed in accordance with examples as disclosed herein. In some examples, aspects of the operations of 1525 may be performed by an energy harvesting report component 840 as described with reference to FIG. 8.

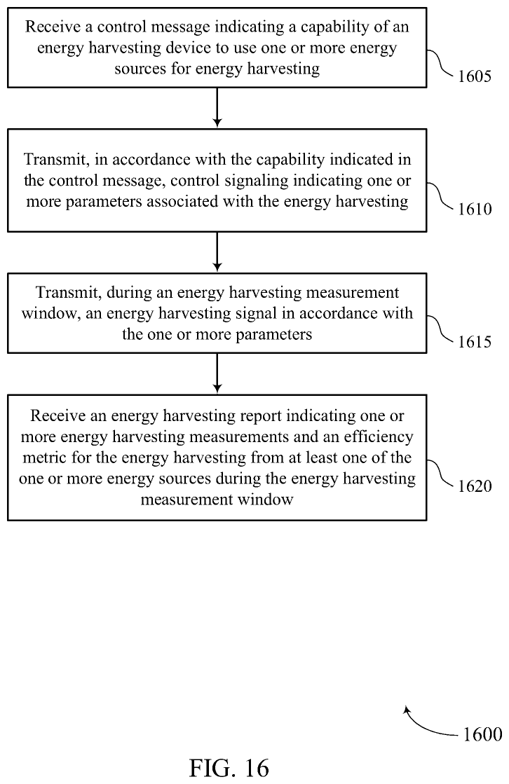

FIG. 16 illustrates a flowchart showing a method 1600 that supports energy harvesting capability report for ambient energy harvesting devices in accordance with one or more aspects of the present disclosure. The operations of the method 1600 may be implemented by a UE or a network entity or its components as described herein. For example, the operations of the method 1600 may be performed by a UE 115 as described with reference to FIGS. 1 through 9 or a network entity as described with reference to FIGS. 1 through 5 and 10 through 13. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1605, the method may include receiving a control message indicating a capability of an energy harvesting device to use one or more energy sources for energy harvesting. The operations of 1605 may be performed in accordance with examples as disclosed herein. In some examples, aspects of the operations of 1605 may be performed by an energy harvesting capability component 825 or an energy harvesting capability component 1225 as described with reference to FIGS. 8 and 12.

At 1610, the method may include transmitting, in accordance with the capability indicated in the control message, control signaling indicating one or more parameters associated with the energy harvesting. The operations of 1610 may be performed in accordance with examples as disclosed herein. In some examples, aspects of the operations of 1610 may be performed by an energy harvesting configuring component 845 or an energy harvesting configuring component 1230 as described with reference to FIGS. 8 and 12.

At 1615, the method may include transmitting, during an energy harvesting measurement window, an energy harvesting signal in accordance with the one or more parameters. The operations of 1615 may be performed in accordance with examples as disclosed herein. In some examples, aspects of the operations of 1615 may be performed by an energy harvesting signal component 850 or an energy harvesting signal component 1235 as described with reference to FIGS. 8 and 12.

At 1620, the method may include receiving an energy harvesting report indicating one or more energy harvesting measurements and an efficiency metric for the energy harvesting from at least one of the one or more energy sources during the energy harvesting measurement window. The operations of 1620 may be performed in accordance with examples as disclosed herein. In some examples, aspects of the operations of 1620 may be performed by a report reception component 855 or a report reception component 1240 as described with reference to FIGS. 8 and 12.

The following provides an overview of aspects of the present disclosure:

Aspect 1: A method for wireless communications at an energy harvesting device, comprising: transmitting a control message indicating a capability of the energy harvesting device to use one or more energy sources for energy harvesting; receiving, in accordance with the capability indicated in the control message, control signaling indicating one or more parameters associated with the energy harvesting; performing, during an energy harvesting measurement window, an energy harvesting procedure in accordance with the one or more parameters to produce one or more energy harvesting measurements; and transmitting an energy harvesting report indicating the one or more energy harvesting measurements and an efficiency metric for the energy harvesting from at least one of the one or more energy sources during the energy harvesting measurement window.

Aspect 2: The method of aspect 1, wherein transmitting the control message comprises: transmitting the control message indicating the capability of the energy harvesting device to use a solar-based energy source, a radio frequency-based energy source, a wind-based energy source, a thermal-based energy source, or any combination thereof, for the energy harvesting.

Aspect 3: The method of any of aspects 1 through 2, wherein receiving the control signaling comprises: receiving the control signaling indicating the one or more parameters that identifies a duty cycle parameter for an energy harvesting signal, wherein performing the energy harvesting procedure is based at least in part on the duty cycle parameter for the energy harvesting signal.

Aspect 4: The method of any of aspects 1 through 3, wherein the energy harvesting report identifies the efficiency metric for one energy source of the one or more energy sources based at least in part on the one energy source having a highest efficiency metric among the one or more energy sources.

Aspect 5: The method of any of aspects 1 through 4, wherein the efficiency metric is power harvesting efficiency, energy harvesting efficiency, conversion efficiency, or any combination thereof.

Aspect 6: The method of any of aspects 1 through 5, wherein transmitting the energy harvesting report comprises: transmitting the energy harvesting report indicating the one or more energy harvesting measurements that identifies a respective efficiency of each energy source of the one or more energy sources based at least in part on performing the energy harvesting procedure.

Aspect 7: The method of aspect 6, wherein the energy harvesting report indicates a respective highest efficiency of each energy source during the energy harvesting measurement window.

Aspect 8: The method of any of aspects 6 through 7, wherein the energy harvesting report indicates a respective average efficiency of each energy source during the energy harvesting measurement window.

Aspect 9: The method of any of aspects 1 through 8, wherein transmitting the energy harvesting report comprises: transmitting the energy harvesting report periodically, wherein the one or more parameters indicate a periodicity for the energy harvesting report.

Aspect 10: The method of any of aspects 1 through 9, further comprising: receiving a grant scheduling a resource for the energy harvesting report, wherein the energy harvesting report is transmitted using the resource.

Aspect 11: The method of any of aspects 1 through 10, further comprising: detecting a trigger to transmit the energy harvesting report, wherein the energy harvesting report is transmitted based at least in part on the trigger.

Aspect 12: The method of aspect 11, wherein the trigger is based at least in part on an efficiency of an energy source of the one or more energy sources failing to satisfy a first threshold or an energy harvesting measurement of the one or more energy harvesting measurements failing to satisfy a second threshold, or both.

Aspect 13: The method of aspect 12, wherein the one or more parameters associated with the energy harvesting includes the first threshold or the second threshold, or both.

Aspect 14: The method of any of aspects 11 through 13, wherein the energy harvesting procedure is performed based at least in part on detecting the trigger.

Aspect 15: The method of any of aspects 1 through 14, wherein transmitting the control message comprises: transmitting the control message indicating a respective sensitivity threshold for one or more operations.

Aspect 16: The method of aspect 15, wherein the control message indicates, for each operation of the one or more operations, a first sensitivity threshold based at least in part on using an external energy source and a second sensitivity threshold based at least in part on not using the external energy source.

Aspect 17: The method of any of aspects 15 through 16, wherein the respective sensitivity threshold for the one or more operations is based at least in part on a traffic priority or a latency associated with each operation of the one or more operations.

Aspect 18: The method of any of aspects 1 through 17, wherein transmitting the control message comprises: transmitting the control message indicating one or more external energy sources of the energy harvesting device.

Aspect 19: The method of aspect 18, wherein the control message indicates support for using a variable energy draw from the one or more external energy sources.

Aspect 20: The method of any of aspects 1 through 19, wherein transmitting the control message comprises: transmitting the control message indicating an energy storage component of the energy harvesting device.

Aspect 21: The method of aspect 20, wherein the energy storage component includes a capacitor or a battery, or both.

Aspect 22: The method of any of aspects 20 through 21, wherein the control message indicates a power capacity, a power density, a cycle life, a duty cycle, a maximum recharging current, a fast charging time, a charge efficiency, a standard discharge current, a maximum discharge current, a self-discharge rate, a cut-off voltage, a supported charge mode, a capability to deep discharge, temperature effects, or any combination thereof, of the energy storage component.

Aspect 23: The method of any of aspects 20 through 22, wherein the control message indicates a capacitance, a working voltage, a leakage current, a tolerance, a temperature coefficient, a polarization, or any combination thereof, of the energy storage component.

Aspect 24: A method for wireless communications at a network entity, comprising: receiving a control message indicating a capability of an energy harvesting device to use one or more energy sources for energy harvesting; transmitting, in accordance with the capability indicated in the control message, control signaling indicating one or more parameters associated with the energy harvesting; transmitting, during an energy harvesting measurement window, an energy harvesting signal in accordance with the one or more parameters; and receiving an energy harvesting report indicating one or more energy harvesting measurements and an efficiency metric for the energy harvesting from at least one of the one or more energy sources during the energy harvesting measurement window.

Aspect 25: The method of aspect 24, wherein receiving the control message comprises: receiving the control message indicating the capability of the energy harvesting device to use a solar-based energy source, a radio frequency-based energy source, a wind-based energy source, a thermal-based energy source, or any combination thereof, for the energy harvesting.

Aspect 26: The method of any of aspects 24 through 25, wherein transmitting the control signaling comprises: transmitting the control signaling indicating the one or more parameters that identifies a duty cycle parameter for an energy harvesting signal, wherein the energy harvesting signal is transmitted in accordance with the duty cycle parameter.

Aspect 27: The method of any of aspects 24 through 26, wherein the energy harvesting report identifies the efficiency metric for one energy source of the one or more energy sources based at least in part on the one energy source having a highest efficiency metric among the one or more energy sources during the energy harvesting measurement window.

Aspect 28: The method of any of aspects 24 through 27, wherein receiving the energy harvesting report comprises: receiving the energy harvesting report indicating the one or more energy harvesting measurements that identifies a respective efficiency of each energy source of the one or more energy sources during the energy harvesting measurement window.

Aspect 29: The method of any of aspects 24 through 28, wherein receiving the energy harvesting report comprises: receiving the energy harvesting report periodically, wherein the one or more parameters indicate a periodicity for the energy harvesting report.

Aspect 30: The method of any of aspects 24 through 29, further comprising: transmitting a grant scheduling a resource for the energy harvesting report, wherein the energy harvesting report is transmitted using the resource.

Aspect 31: An apparatus for wireless communications at an energy harvesting device, comprising a processor; memory coupled with the processor; and instructions stored in the memory and executable by the processor to cause the apparatus to perform a method of any of aspects 1 through 23.

Aspect 32: An apparatus for wireless communications at an energy harvesting device, comprising at least one means for performing a method of any of aspects 1 through 23.

Aspect 33: A non-transitory computer-readable medium storing code for wireless communications at an energy harvesting device, the code comprising instructions executable by a processor to perform a method of any of aspects 1 through 23.

Aspect 34: An apparatus for wireless communications at a network entity, comprising a processor; memory coupled with the processor; and instructions stored in the memory and executable by the processor to cause the apparatus to perform a method of any of aspects 24 through 30.

Aspect 35: An apparatus for wireless communications at a network entity, comprising at least one means for performing a method of any of aspects 24 through 30.

Aspect 36: A non-transitory computer-readable medium storing code for wireless communications at a network entity, the code comprising instructions executable by a processor to perform a method of any of aspects 24 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers.

Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at an energy harvesting device, comprising:
a processor;
memory coupled with the processor; and
instructions stored in the memory and executable by the processor to cause the apparatus to:
transmit a control message indicating a capability of the energy harvesting device to use one or more energy sources for energy harvesting;
receive, in accordance with the capability indicated in the control message, control signaling indicating one or more parameters associated with the energy harvesting;
perform, during an energy harvesting measurement window, an energy harvesting procedure in accordance with the one or more parameters to produce one or more energy harvesting measurements; and
transmit an energy harvesting report indicating the one or more energy harvesting measurements and an efficiency metric for the energy harvesting from at least one of the one or more energy sources during the energy harvesting measurement window.

2. The apparatus of claim 1, wherein the instructions to transmit the control message are executable by the processor to cause the apparatus to:
transmit the control message indicating the capability of the energy harvesting device to use a solar-based energy source, a radio frequency-based energy source, a wind-based energy source, a thermal-based energy source, or any combination thereof, for the energy harvesting.

3. The apparatus of claim 1, wherein the instructions to receive the control signaling are executable by the processor to cause the apparatus to:
receive the control signaling indicating the one or more parameters that identifies a duty cycle parameter for an energy harvesting signal, wherein performing the energy harvesting procedure is based at least in part on the duty cycle parameter for the energy harvesting signal.

4. The apparatus of claim 1, wherein the energy harvesting report identifies the efficiency metric for one energy source of the one or more energy sources based at least in part on the one energy source having a highest efficiency metric among the one or more energy sources.

5. The apparatus of claim 1, wherein the efficiency metric is power harvesting efficiency, energy harvesting efficiency, conversion efficiency, or any combination thereof.

6. The apparatus of claim 1, wherein the instructions to transmit the energy harvesting report are executable by the processor to cause the apparatus to:
transmit the energy harvesting report indicating the one or more energy harvesting measurements that identifies a respective efficiency of each energy source of the one or more energy sources based at least in part on performing the energy harvesting procedure.

7. The apparatus of claim 6, wherein the energy harvesting report indicates a respective highest efficiency of each energy source during the energy harvesting measurement window.

8. The apparatus of claim 6, wherein the energy harvesting report indicates a respective average efficiency of each energy source during the energy harvesting measurement window.

9. The apparatus of claim 1, wherein the instructions to transmit the energy harvesting report are executable by the processor to cause the apparatus to:
transmit the energy harvesting report periodically, wherein the one or more parameters indicate a periodicity for the energy harvesting report.

10. The apparatus of claim 1, wherein the instructions are further executable by the processor to cause the apparatus to:
receive a grant scheduling a resource for the energy harvesting report, wherein the energy harvesting report is transmitted using the resource.

11. The apparatus of claim 1, wherein the instructions are further executable by the processor to cause the apparatus to:
detect a trigger to transmit the energy harvesting report, wherein the energy harvesting report is transmitted based at least in part on the trigger.

12. The apparatus of claim 11, wherein the trigger is based at least in part on an efficiency of an energy source of the one or more energy sources failing to satisfy a first threshold or an energy harvesting measurement of the one or more energy harvesting measurements failing to satisfy a second threshold, or both.

13. The apparatus of claim 12, wherein the one or more parameters associated with the energy harvesting includes the first threshold or the second threshold, or both.

14. The apparatus of claim 11, wherein the energy harvesting procedure is performed based at least in part on detecting the trigger.

15. The apparatus of claim 1, wherein the instructions to transmit the control message are executable by the processor to cause the apparatus to:
transmit the control message indicating a respective sensitivity threshold for one or more operations.

16. The apparatus of claim 15, wherein the control message indicates, for each operation of the one or more operations, a first sensitivity threshold based at least in part on using an external energy source and a second sensitivity threshold based at least in part on not using the external energy source.

17. The apparatus of claim 15, wherein the respective sensitivity threshold for the one or more operations is based at least in part on a traffic priority or a latency associated with each operation of the one or more operations.

18. The apparatus of claim 1, wherein the instructions to transmit the control message are executable by the processor to cause the apparatus to:
transmit the control message indicating one or more external energy sources of the energy harvesting device.

19-23. (canceled)

24. An apparatus for wireless communications at a network entity, comprising:
a processor;
memory coupled with the processor; and
instructions stored in the memory and executable by the processor to cause the apparatus to:
receive a control message indicating a capability of an energy harvesting device to use one or more energy sources for energy harvesting;
transmit, in accordance with the capability indicated in the control message, control signaling indicating one or more parameters associated with the energy harvesting;
transmit, during an energy harvesting measurement window, an energy harvesting signal in accordance with the one or more parameters; and
receive an energy harvesting report indicating one or more energy harvesting measurements and an efficiency metric for the energy harvesting from at least one of the one or more energy sources during the energy harvesting measurement window.

25-28. (canceled)

29. A method for wireless communications at an energy harvesting device, comprising:
transmitting a control message indicating a capability of the energy harvesting device to use one or more energy sources for energy harvesting;
receiving, in accordance with the capability indicated in the control message, control signaling indicating one or more parameters associated with the energy harvesting;
performing, during an energy harvesting measurement window, an energy harvesting procedure in accordance with the one or more parameters to produce one or more energy harvesting measurements; and
transmitting an energy harvesting report indicating the one or more energy harvesting measurements and an efficiency metric for the energy harvesting from at least one of the one or more energy sources during the energy harvesting measurement window.

30. (canceled)
